(19) United States
(12) Patent Application Publication
(10) Pub. No.: US 2012/0213061 A1
(43) Pub. Date: Aug. 23, 2012

(54) COGNITIVE RELAY TECHNIQUES

(75) Inventors: Yan Chen, Shanghai (CN); Vincent Kin Nang Lau, Hong Kong (CN); Shunqing Zhang, Shanghai (CN); Peiliang Qiu, Hangzhou (CN)

(73) Assignee: THE HONG KONG UNIVERSITY OF SCIENCE AND TECHNOLOGY, Hong Kong (CN)

(21) Appl. No.: 13/150,711

(22) Filed: Jun. 1, 2011

Related U.S. Application Data
(60) Provisional application No. 61/444,543, filed on Feb. 18, 2011.

(51) Int. Cl. H04W 88/04; H04W 24/04; H04B 3/36

(52) U.S. Cl. 370/227; 370/315; 370/293

(57) ABSTRACT

The subject specification comprises a cognitive relay communications management (CRCM) component associated with a primary communication system, wherein the CRCM component controls relaying at least a portion of transmitted communications from a secondary source device (SSD) transmitting data to a secondary destination device (SDD) associated with a secondary communication system, in accordance with a specified relay protocol, such as a buffered decode-and-forward protocol. The CRCM component identifies when the secondary relay station (SRS) is not transmitting on the relay-destination (R-D) link and the source-relay link is not blocked, and, in such instance, allows transmission of a packet from the SSD to the SRS. The SRS forwards the packet to the SDD when the CRCM component identifies when the R-D link is not blocked. The SRS and/or SSD remove the packet from their respective queues when an acknowledgement message(s) is received from the SDD and/or SRS, respectively.

### CROSS-REFERENCE TO RELATED APPLICATION AND CLAIM FOR PRIORITY

This application is a non-provisional of, and claims the benefit of, U.S. Provisional Patent Application No. 61/444,543, filed Feb. 18, 2011, and titled “PROTOCOL DESIGN AND STABILITY-DELAY ANALYSIS OF HALF-DUPLEX BUFFERED COGNITIVE RELAY SYSTEMS”, which is hereby incorporated herein by reference in its entirety.

### TECHNICAL FIELD

The disclosed subject matter generally relates to wireless communications, and, more particularly, to buffered cognitive relay techniques for wireless communications.

### BACKGROUND

Today, there are many types of wireless communication, including, for example, cellular phone communications, television and radio communications, communications relating to wireless microphones, communications relating to other types of transmitters or transceivers, etc. These respective types of wireless communication typically utilize respective portions of the spectrum. Often, with regard to a primary communication system, there can be under-utilized spectrum holes in the primary communication system, for example, when the number of primary communication devices using the primary communication system, or the amount of communication between the primary communication devices, do not utilize the available spectrum associated with the primary communication system.

Cognitive radio transmission is a technique that can allow secondary communication devices (also referred to as secondary users (SUs)) to exploit the under-utilized spectrum holes left by the primary communication system, either in temporal, frequency or spatial domain, without interfering with the regular transmissions of the primary communication devices (also referred to as primary users (PUs)).

One issue of the cognitive radio (CR) system is on the efficiency of spectrum sharing with the PU system. Direct transmission, which demands large transmit power, ends up with small opportunity of access and hence low spectrum sharing efficiency. As such, CR combined with a relay station (RS), referred to as cognitive relay system (CRS), appears as an attractive solution to boost the spectrum sharing efficiency.

The majority of the existing works on CRS have focused on the physical layer aspects of the problem. For example, a distributed algorithm for channel access and power control has been proposed for cognitive multi-hop relays, and a channel selection policy for multi-hop cognitive mesh network has been considered. When delay-sensitive applications are considered, other performance measures, such as the stability region and the average end-to-end packet delay become critical. At least one work has analyzed the delay of a cognitive relay assisted multi-access network, however, that work did not consider the impact of PU activities and dynamic spectrum sharing. Moreover, in the conventional works, the coverage of the PU system is assumed to be much larger than the coverage of the SU system, so the spatial burstiness of the primary traffic and its impact on the CRS have not been fully investigated and considered.

Currently, there is no CRS that has accounted for and addressed the issues relating to the impact of PU activities and dynamic spectrum sharing, and spatial burstiness of the primary traffic (e.g., transmission by PUs) and its impact on the CRS in the typical situation where the coverage area of the SU system is significantly larger than the coverage area of the PU system. The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

The following presents a simplified summary of the disclosed subject matter in order to provide a basic understanding of some aspects of the disclosed subject matter. This summary is not an extensive overview of the disclosed subject matter. It is intended to neither identify key or critical elements of the disclosed subject matter nor delineate the scope of the disclosed subject matter. Its sole purpose is to present some concepts of the disclosed subject matter in a simplified form as a prelude to the more detailed description that is presented later.

The subject specification can facilitate communications using cognitive relay in accordance with various aspects and embodiments of the disclosed subject matter. The subject specification comprises a cognitive relay communications management (CRCM) component associated with a primary communication system, wherein the CRCM component can control relay of at least a portion of transmitted communications from a secondary source device (SSD) transmitting data to a secondary destination device (SDD) associated with a secondary communication system (e.g., base station communicating data packets to user equipment (UE); or UE communicating data packets to a base station), in accordance with a specified relay protocol (e.g., a buffered decode-and-forward (BDL) protocol, simple decode-and-forward (SDF) protocol).

In one embodiment, the CRCM component can identify when the secondary relay station (SRS) (e.g., consumer premises equipment (CPE) or other device that transmits or receives voice or data communications), which is associated with the primary communication system, is not transmitting on the relay-destination (R-D) link and the source-relay (S-R) link is not blocked, and, in such instance, allows transmission of a packet of voice or data information from the SSD to the SRS, in accordance with the specified relay protocol (e.g., BDL protocol), wherein the packet can be a copy of a corresponding original packet maintained in an SSD queue component. In an aspect, the CRCM component of the SRS can decode the received packet to obtain or derive the voice or data information contained in the packet, can encode the voice or data information to generate a corresponding version of the packet for transmission to the SDD, and insert the corresponding version of the packet in the SRS queue component of the SRS. In an aspect, the CRCM component also can transmit an acknowledgement message (e.g., ACK message or signal) to the SSD to notify the SSD that the packet was successfully received by the SRS, wherein, in one embodiment, the SSD can remove the corresponding original packet from the SSD queue component, or, in another embodiment, the SSD can maintain the knowledge that the packet was received by the SRS so that the SSD does not try to re-send the packet to the SRS or directly to the SDD and can continue to maintain the corresponding original packet in the SSD queue component until an acknowledgement message is received from the SDD to indicate that the SDD has successfully received the packet, or the SSD can move the corresponding original packet from the SSD queue component to another queue component or a data store while awaiting an acknowledgement message, which indicates a packet (e.g., copy of a corresponding version of the packet) was received by the SDD, from the SDD.

In another aspect, the CRCM component can identify when the R-D link is not blocked, and, in such instance, can generate a copy of the corresponding version of the packet and forward (e.g., transmit) the copy of the corresponding version of the packet to the SDD, while maintaining the corresponding version of the packet in the SRS queue component until an acknowledgement message, which indicates the SDD successfully received the copy of the corresponding version of the packet, is received from the SDD. Upon the SDD receiving the copy of the corresponding version of the packet, the SDD can transmit or broadcast an acknowledgement message (e.g., ACK) to the SRS and/or SSD. In response to receiving the acknowledgement message, the SRS and/or SSD can remove the packet from their respective queue components, and a next packet (if any) can be processed for transmission, in accordance with the specified relay protocol. In an aspect, the respective queue components (e.g., packet transmission queues) of the SRS and the SSD can be maintained in a stable condition and/or synchronized condition simultaneously or substantially simultaneously, in accordance with the stability region associated with the cognitive relay system.

In instances where the CRCM component determines the SRS is transmitting on the R-D link and/or the S-R link is blocked, the CRCM component can indicate that the packet cannot be received and relayed at that time. In an aspect, at desired times (e.g., whenever the source-destination (S-D) link is not blocked and/or is otherwise available for communications, and/or whenever a packet cannot be transmitted to the SRS), the SSD can transmit the packet (e.g., a copy of the original packet maintained in the SSD queue component) via a direct wireless communication connection or channel, such as the S-D link, to the SDD. In response to receiving the packet, the SDD can transmit or broadcast an acknowledgement message the SSD. In response to receiving the acknowledgement message, the SSD can remove the corresponding original packet from the SSD queue component, and a next packet (if any) can be processed for transmission, in accordance with the specified relay protocol.

In accordance with various aspects, the disclosed subject matter can comprise a system that includes a SRS configured to control communications associated with one or more primary communication devices associated with a primary communication system. The system can further include a CRCM component configured to control reception of a packet of information by the SRS from a SSD and communication of a corresponding version of the packet of information by the SRS to a SDD based at least in part on respective activity states of at least a portion of the one or more primary communication devices, in accordance with a specified relay protocol, wherein the SSD and the SDD are associated with a secondary communication system.

In accordance with various other aspects, the disclosed subject matter can comprise a method that includes the acts of receiving a packet, which is destined for a SDD, from a SSD at a secondary relay device (SRD) in response to a source-relay (S-R) link between the SSD and SRD not being blocked and there being no other condition restricting the receiving of the packet, based at least in part on respective activity states of at least a portion of one or more primary communication devices associated with a primary communication network in relation to the S-R link, in accordance with at least one predefined relay criterion; and transmitting a corresponding version of the packet, comprising voice or data information of the packet, to relay the corresponding version of the packet to the SDD, based at least in part on respective activity states of at least a portion of one or more primary communication devices associated with a primary communication network, in accordance with the at least one predefined relay criterion, wherein the SSD and SDD are associated with a secondary communication network.

In accordance with still other aspects, the disclosed subject matter can comprise a system that includes means for receiving a packet, which is destined for a SDD, from a SSD at a SRD in response to a S-R link between the SSD and SRD not being blocked and there being no other condition restricting the receiving of the packet, based at least in part on respective activity states of at least a portion of one or more primary communication devices associated with a primary communication system in relation to the S-R link, in accordance with at least one predefined relay criterion. The system further includes means for transmitting a corresponding version of the packet, comprising voice or data information of the packet, to relay the corresponding version of the packet to the SDD, based at least in part on respective activity states of at least a portion of one or more primary communication devices associated with a primary communication system, in accordance with the at least one predefined relay criterion, wherein the SSD and SDD are associated with a secondary communication system.

In accordance with still other aspects, the disclosed subject matter can comprise a computer-readable medium having stored thereon, computer-executable instructions that, when executed by a computing device, cause the computing device to perform the following operations: receiving a packet, which is destined for a SDD, from a SSD at a SRD in response to a S-R link between the SSD and SRD being free and there being no other condition restricting the receiving of the packet, based at least in part on respective activity states of at least a portion of one or more primary communication devices associated with a primary communication network in relation to the S-R link, in accordance with at least one predefined relay criterion; and transmitting a corresponding version of the packet, comprising voice or data information of the packet, to relay the corresponding version of the packet to the SDD, based at least in part on respective activity states of at least a portion of one or more primary communication devices associated with a primary communication network, in accordance with the at least one predefined relay criterion, wherein the SSD and SDD are associated with a secondary communication network.

In yet other aspects, the disclosed subject matter can comprise a system that includes means for a SSD configured to transmit at least a first portion of a set of packets via a source-destination communication link to a SDD, and a second portion of the set of packets via a source-relay communication link to a SRS to have the SRS forward the second portion of the set of packets to the SDD via a relay-destination communication link. The system also comprises means for a communication management component configured to control transmission of a packet of the second portion of the set of packets to the SRS based at least in part on respective activity states of at least a portion of one or more primary communication devices associated with a primary communication system, in accordance with a specified relay protocol, wherein the SSD and the SDD are associated with a secondary communication system.

To the accomplishment of the foregoing and related ends, the disclosed subject matter, then, comprises the features hereinafter fully described. The following description and the annexed drawings set forth in detail certain illustrative aspects of the disclosed subject matter. However, these aspects are indicative of but a few of the various ways in which the principles of the disclosed subject matter may be employed. Other aspects, advantages and novel features of the disclosed subject matter will become apparent from the following detailed description of the disclosed subject matter when considered in conjunction with the drawings.

### BRIEF DESCRIPTION OF DRAWINGS

FIG. 1 is a block diagram of an example system that can facilitate communications using cognitive relay in accordance with various aspects and embodiments of the disclosed subject matter.

FIG. 2 depicts a block diagram of an example system that can facilitate communications using cognitive relay in accordance with various aspects and embodiments of the disclosed subject matter.

FIG. 3 depicts a block diagram of example systems comprising a cognitive system and a cognitive relay system (CRS) that can utilize a desired relay protocol in accordance with various aspects and embodiments of the disclosed subject matter.

FIG. 4 illustrates an example graph of path-loss gain of CRS over a baseline system with different distances of a secondary relay system (SRS) in accordance with various aspects.

FIG. 5 presents an example graph of buffer gain in both stability region and average end-to-end delay of CRS under the buffered decode-and-forward (BDF) protocol over that under the simple decode-and-forward (SDF) protocol with different primary user (PU) activity intensity π₀ in accordance with various aspects.

FIG. 6 illustrates an example graph an example graph of average end-to-end delay under the BDF, SDF, and BL protocols with different PU activity intensity πₒ in accordance with various aspects.

FIG. 7 depicts a block diagram of an example system that can facilitate communications using cognitive relay in accordance with various aspects and embodiments of the disclosed subject matter.

FIG. 8 is a block diagram of an example SRS in accordance with various aspects and embodiments of the disclosed subject matter.

FIG. 9 illustrates a block diagram of an example secondary destination device (SDD) in accordance with various aspects and embodiments of the disclosed subject matter.

FIG. 10 depicts a block diagram of an example secondary source device (SSD) in accordance with various aspects and embodiments of the disclosed subject matter.

FIG. 11 presents a flowchart of an example method for controlling relaying of packets of information in a CRS, in accordance with various aspects and embodiments of the disclosed subject matter.

FIG. 12 depicts a flowchart of an example method that can employ a BDF protocol to facilitate controlling relaying of packets of information in a CRS, in accordance with various aspects and embodiments of the disclosed subject matter.

FIG. 13 illustrates a flowchart of an example method that can employ an SDF protocol to facilitate controlling relaying of packets of information in a CRS, in accordance with various aspects and embodiments of the disclosed subject matter.

FIG. 14 illustrates a flowchart of an example method that can employ a BDF protocol to facilitate controlling relaying of packets of information in a CRS, in accordance with various aspects and embodiments of the disclosed subject matter.

FIG. 15 presents a flowchart of an example method that can employ an SDF protocol to facilitate controlling relaying of packets of information in a CRS, in accordance with various aspects and embodiments of the disclosed subject matter.

FIG. 16 illustrates a flowchart of an example method that can employ a BL protocol to facilitate controlling transmitting packets of voice or data information in a CRS, in accordance with various aspects and embodiments of the disclosed subject matter.

FIG. 17 depicts a flowchart of an example method that can facilitate controlling communication of voice or data information between an SSD and an SDD associated with a CRS, in accordance with various aspects and embodiments of the disclosed subject matter.

FIG. 18 is a schematic block diagram illustrating a suitable operating environment.

FIG. 19 is a schematic block diagram of a sample-computing environment.

### DETAILED DESCRIPTION

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment,” “mobile station,” “mobile,” “subscriber station,” “communication device,” “access terminal,” “terminal,” “handset,” and similar terminology, refer to a wireless device (e.g., cellular phone, smart phone, computer, personal digital assistant (PDA), set-top box, Internet Protocol Television (IPTV), electronic gaming device, multi-media recorder/player, video recorder/player, audio recorder/player, printer, etc.) utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B (I-INB),” and the like, are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

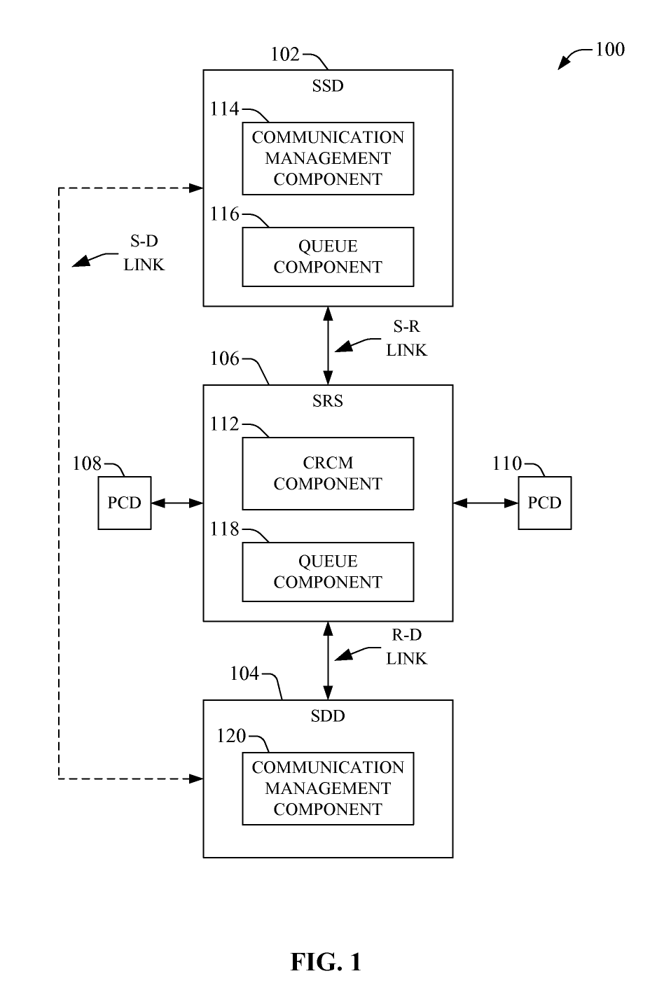

Referring to the drawings, FIG. 1 is a block diagram of an example system 100 that can facilitate communications using cognitive relay in accordance with various aspects and embodiments of the disclosed subject matter. In an aspect, the system 100 can comprise a secondary source device (SSD) 102 that can transmit voice or data communications (e.g., in the form of voice or data packets) to a secondary destination device (SDD) 104, which can receive the voice or data communications, wherein the SSD 102 and SDD 104 can be associated with a secondary communication system (e.g., cellular communication system). While SSD 102 is referred to here as being the transmitting device and the SDD 104 is referred to here as being the receiving device, it is to be appreciated and understood that the SSD 102 also can receive communications from, for example, the SDD 104, and the SDD 104 can transmit voice or data communications to, for example, the SSD 102. For example, the SSD 102 can be a base station (e.g., macro or cellular base station), and the SDD 102 can be user equipment (UE). In accordance with various embodiments, the UE can be a mobile or wireless communication device, such as, for example, a mobile phone (e.g., 3GPP UMTS phone), a personal digital assistant (PDA), a computer, an information server (e.g., video server, audio server, multimedia server, news server, etc.), an IP television (IPTV), an electronic gaming console, a set-top box, a multi-media recorder/player, a video recorder/player, an audio recorder/player, a printer, or a multi-mode printer (e.g., printer, scanner, facsimile, etc.).

For instance, the SDD 104 can be located in a wireless portion (e.g., region) of a communication network, for example. The SDD 104 can be connected (e.g., wirelessly connected) to the SSD 102, which can serve a specified coverage area to facilitate communication by the SDD 104 and other SDDs (not shown) in the wireless communication environment. The SSD 102 can serve a respective coverage macro cell that can cover a specified area, and the SSD 102 can service mobile wireless devices, such as SDD 104, located in the respective area covered by the macro cell, where such coverage can be achieved via a wireless link (e.g., uplink (UL), downlink (DL)). When an attachment attempt is successful, the SDD 104 can be served by the SSD 102, and incoming voice and data traffic can be paged and routed to the SDD 104 through the SSD 102, and outgoing voice and data traffic from the SDD 104 can be paged and routed through the SSD 102 to other communication devices (e.g., another SDD). In an aspect, the SDD 104 can be connected and can communicate wirelessly using virtually any desired wireless technology, including, for example, cellular, Wi-Fi, Wi-Max, wireless local area networks (WLAN), etc.

In accordance with various aspects and embodiments, the system 100 can employ cognitive relay to more efficiently utilize a primary communication system, such as under-utilized spectrum (e.g., licensed or unlicensed spectrum) in the primary communication system, having a coverage area that encompasses the location of the SDD 104 to communicate at least a portion of the voice or data communications from the SSD 102 to the SDD 104 (or vice versa) via the primary communication system. In an aspect, the system 100 can include a secondary relay station (SRS) 106, which can be associated with the primary communication system to facilitate communications between primary communication devices, but also can be associated with the secondary communication system to facilitate communication of at least a portion of voice or data communications between the SSD 102 and the SDD 104, in accordance with a specified relay protocol (e.g., a buffered decode-and-forward (BDL) protocol, a simple decode-and-forward (SDF) protocol). In an embodiment, the SRS 106 can be a half-duplex cognitive relay station.

In accordance with various embodiments, the SRS 106 can operate as a primary base station or other type of primary transceiver for primary communication devices, such as primary communication device 108 and primary communication device 110, communicating in the primary communication system. The primary communication devices 108 and 110, respectively, can be, for example, a mobile or wireless communication device, such as, for example, a wireless microphone, a mobile phone (e.g., 3GPP UMTS phone), a PDA, a computer, an information server, an IPTV, an electronic gaming console, a set-top box, a multi-media recorder/player, a video recorder/player, an audio recorder/player, a printer, or a multi-mode printer. In accordance with various aspects, the SRS 106 can be employed to facilitate communication between primary communication device 108 and primary communication devices 110 (e.g., via wireless communication connections), or can facilitate communication between only the SRS 106 and a primary communication device (e.g., 108) (e.g., wherein the SRS 106 can communicate voice or data via a wireline communication connection).

As disclosed herein, often, with regard to a primary communication system, there can be under-utilized spectrum holes in the primary communication system, for example, when the number of primary communication devices using the primary communication system, or the amount of communication between the primary communication devices, do not utilize the available spectrum associated with the primary communication system. Cognitive radio transmission is a technique that can allow secondary devices (also referred to herein as secondary users (SUs)) to exploit the under-utilized spectrum holes left by the primary communication system, either in temporal, frequency or spatial domain, without interfering with the regular transmissions of the primary devices (also referred to herein as primary users (PUs)), such as primary communication devices 108 and 110.

One significant issue of the cognitive radio (CR) system is with regard to the efficiency of spectrum sharing with the primary communication system (e.g., PU system). For instance, direct transmission, which demands large transmit power, ends up with small opportunity of access and hence low spectrum sharing efficiency. However, CR combined with a relay station (RS), referred to as cognitive relay system (CRS), can be an attractive solution to boost the spectrum sharing efficiency. However, conventional CRS systems are deficient for a number of reasons, including, for instance, conventional CRS systems have not accounted for or addressed issues relating to the impact of PU activities and dynamic spectrum sharing, and spatial burstiness of the primary traffic (e.g., transmission by PUs) and its impact on the CRS in the typical situation where the coverage area of the SU system is significantly larger than the coverage area of the PU system.

The subject specification provides for an enhanced CRS that overcomes the deficiencies of conventional relay systems, methods, and techniques. As more fully disclosed herein, the disclosed subject matter can provide for improved path-loss gain and buffer gain over conventional relay systems, methods, and techniques. In accordance with various embodiments of the disclosed subject matter, the path-loss gain can substantially increase the spectrum access opportunities, for example, by reducing the transmit power, while the buffering capability at the relay station (e.g., SRS 106) can further save the blockage time of either the source-relay (S-R) link or relay-destination (R-D) link and reduce the end-to-end delay to a larger extent than that of conventional relay systems, methods, and techniques. In accordance with various embodiments, the use of a relay buffer can better manage the uncertainty of PU communication activities, which is an intrinsic issue associated with large-coverage cognitive systems.

In accordance with various aspects and embodiments, in order to facilitate reducing the interference region that can be caused by SU transmission, the SSD 102 and SRS 106 each can comprise antenna arrays, including a specified number of antennas, that can be equipped for beamforming, with bandwidth θ and transmit antenna gain Gₜ. The beamforming can increase the average receiving signal-to-noise ratio (SNR) at the SDD 104, although it is noted that the instantaneous receiving SNR may still follow Rayleigh fading due at least in part to the local scattering cluster. Since the SRS 106 can operate in half-duplex mode, the SRS 106 can use the antenna ray to facilitate obtaining the receiving antenna gain Gᵣ. In an embodiment, the SDD 104 can employ one omnidirectional antenna. In an aspect, the transmission time of the system 100 can be slotted, as disclosed herein.

In an aspect, the SRS 106 can comprise a cognitive relay communications management (CRCM) component 112 that can control relay of at least a portion of communications transmitted from SSD 102 to the SDD 104, in accordance with the specified relay protocol (e.g., BDL protocol, SDF protocol). In accordance with various embodiments, the CRCM component 112 can monitor communication links (e.g., monitor whether voice or data is being communicated via the communication links), such as the S-R link, which can be the communication link or channel between the SSD 102 and SRS 106, and/or R-D link, which can be the communication link or channel between the SRS 106 and SDD 104, and/or can monitor communication conditions (e.g., quality of wireless communication link, whether the wireless communication link is blocked or not, etc.) associated the S-R link and/or R-D link, depending in part on the particular relay protocol being employed. In an aspect, the CRCM component 112 can monitor, obtain, and/or identify channel state information (CSI) of the R-D link, so that the CRCM component 112 can have knowledge of the channel state and the channel outage time of the R-D link, which can be further saved for S-R link transmission.

In another aspect, the CRCM component 112 also can monitor communication conditions associated with PUs (e.g., primary communication devices 108 and/or 110) associated with the SRS 106 (e.g., respective activity states of a specified subset of respective PUs associated with the CRCM component 112, quality of wireless communication link associated with a PU, etc.), and can sense, detect, receive, or otherwise obtain information relating to communication conditions. For example, communication condition information can be received from one or more sensors (e.g., cognitive sensors, communication link quality sensors, etc.) (not shown in FIG. 1), which can be distributed throughout the communication network environment, as more fully disclosed herein. The CRCM component 112 can analyze the received communication condition information and can identify or determine respective activity states of a specified subset (e.g., all or a portion) of respective PUs in relation to a communication link (e.g., S-R link, R-D link) at a given time (e.g., a time at or near when the SSD 102 desires to transmit a packet to the SRS 106). The CRCM component 112 can identify or determine whether a particular communication link is blocked, based at least in part on the respective activity states of a specified subset (e.g., all or a desired portion) of the respective PUs in relation to that particular communication link and/or a link block indicator variable (e.g., a(Pᵢⱼ) for a link ij), as more fully disclosed herein.

In an aspect, the SSD 102 can desire to transmit voice or data communications, for example, comprising one or more packets (e.g., voice or data packets) to the SDD 104, wherein the voice or data communications can be communicated from another communication device (e.g., UE) (not shown in FIG. 1) associated with the secondary communication system. In an embodiment, the transmission time for transmitting packets can be slotted into a plurality of slots and the packet transmission can start at the beginning of a slot of the plurality of slots. Typically, in each slot, only one packet can be transmitted. In an aspect, when transmitting, the SSD 102 and SRS 106 can use optimal transmit power to improve or maximize the probability of successful transmission over a particular link (e.g., S-R link, R-D link, S-R link).

In another aspect, the SSD 102 can comprise a communication management component 114 that can manage communications (e.g., via the PU or SU), including communications involving cognitive relay, between the SSD 102 and communication devices (e.g., SDD 104) or stations (e.g., SRS 106) associated therewith. The communication management component 114 can include a queue component 116 (e.g., SSD queue component), which can have a size sufficient (e.g., large enough in size, such as a virtually infinite queue size) to store a desired number of packets of information sufficient enough to facilitate employing a SRS, such as SRS 106, as a relay station to communicate at least a portion of a communication to the SDD 104, as disclosed herein. In one embodiment, the queue component 116 can be a first-in-first-out (FIFO) queue, although the queue can be differently structured or can differently function, as desired, in accordance with other embodiments. The packets in the queue component 116 can be encoded and otherwise processed for communication to a next destination (e.g., relay station, such as SRS 106) or final destination (e.g., SDD 104).

In accordance with various aspects and embodiments, the communication management component 114 can monitor communication links, such as the S-R link, which can be the communication link or channel between the SSD 102 and SRS 106, and/or S-D link, which can be the communication link or channel between the SSD 102 and SDD 104, and the R-D link, which can be the communication link or channel between the SRS 106 and SDD 104, and can monitor respective communication conditions (e.g., quality of wireless communication link, whether the wireless communication link is blocked or not, etc.) associated with the S-R link, R-D link, and/or S-D link, depending in part on the particular relay protocol being employed.

In accordance with various aspects, the communication management component 114 also can monitor communication conditions associated with PUs (e.g., primary communication devices 108 and/or 110) associated with the SRS 106 (e.g., respective activity states of a specified subset (e.g., all or a desired portion) of respective PUs associated with the SRS 106, quality of wireless communication link associated with a PU, etc.), and can sense, detect, receive, or otherwise obtain information relating to communication conditions. For example, communication condition information can be received from the one or more sensors (e.g., cognitive sensors, communication link quality sensors, etc.), which can be distributed throughout the communication network environment, as more fully disclosed herein. The communication management component 114 can analyze the received communication condition information and can identify or determine respective activity states of the specified subset of respective PUs in relation to a communication link (e.g., S-R link, R-D link) at a given time (e.g., a time at or near when the SSD 102 desires to transmit a packet to the SRS 106). The communication management component 114 can identify or determine whether a particular communication link is blocked, based at least in part on the respective activity states of the specified subset of respective PUs in relation to that particular communication link and/or a link block indicator variable (e.g., a(Pᵢⱼ) for a link ij), as more fully disclosed herein.

In one embodiment, when system 100 is employing the BDF protocol, the CRCM component 112 can identify whether the SRS 106 is transmitting on the R-D link and whether the S-R link is blocked, as more fully disclosed herein. If the CRCM component 112 identifies that the SRS 106 is not transmitting on the R-D link and the S-R link is not blocked, the CRCM component 112 can allow transmission of a packet (e.g., voice or data packet) from the SSD 102 to the SRS 106. In accordance with various embodiments, the communication management component 114 also can identify whether the SRS 106 is transmitting on the R-D link and whether the S-R link is blocked, as more fully disclosed herein. If the communication management component 114 identifies that the SRS 106 is not transmitting on the R-D link and the S-R link is not blocked, the communication management component 112 can transmit the packet (e.g., voice or data packet) from the SSD 102 to the SRS 106 for relay to the SDD 104 in accordance with the BDF protocol. Additionally or alternatively, the communication management component 114 can receive or obtain information (e.g., receive information from the SRS 106) that indicates whether the SRS 106 is transmitting on the R-D link and/or whether the S-R link is blocked, and can identify whether the SRS 106 is transmitting on the R-D link and whether the S-R link is blocked, based at least in part on such information.

When the communication management component 114 identifies that the SRS 106 is not transmitting on the R-D link and the S-R link is not blocked, the communication management component 114 can determine that the first or next packet in the queue component 116 can be communicated to the SRS 106, and the communication management component 114 can facilitate transmission of that packet to the SRS 106. The SRS 106 can receive the packet, and the CRCM component 112 can store the packet in its queue component 118 (e.g., SRS queue component). In an embodiment, the queue component 118 can be a FIFO queue, although the queue can be differently structured or can differently function, as desired, in accordance with other embodiments. In an aspect, when the packet is received, the CRCM component 112 can decode or otherwise process the packet to obtain or derive the voice or data information contained in the packet, and can encode (e.g., re-encode) and otherwise process the packet, and associated voice or data information, to generate a corresponding version of the packet for transmission to the SSD 104 and insert or store the corresponding version of the packet in the queue component 118.

In an aspect, in response to successfully receiving the packet from the SSD 102, the CRCM component 112 also can transmit an acknowledgement message (e.g., ACK message or signal) to the SSD 102 to notify the SSD 102 that the packet was successfully received by the SRS 106, wherein, in one embodiment, the communication management component 114 of the SSD 102 can remove the corresponding original packet from the SSD queue component 116, or, in another embodiment, the communication management component 114 of the SSD 102 can maintain the knowledge that the packet was received by the SRS 106 so that the SSD 102 does not attempt to re-send the packet to the SRS 106 or directly to the SDD 104 and can continue to maintain the corresponding original packet in the SSD queue component 116 until an acknowledgement message is received from the SDD 104 to indicate that the SDD 104 has successfully received the packet (e.g., a copy of the corresponding version of the packet), or the communication management component 114 of the SSD 102 can move the corresponding original packet from the SSD queue component 116 to another queue component or a data store while awaiting an acknowledgement message, which indicates the packet (e.g., copy of a corresponding version of the packet) was received by the SDD 104, from the SDD 104.

In another aspect, the CRCM component 112 can identify when the R-D link is not blocked, as more fully disclosed herein, and, in such instance, can generate a copy of the corresponding version of the packet contained in the queue component 118 (e.g., first packet in the FIFO queue) and can forward (e.g., transmit) the copy of the corresponding version of the packet from the SRS 106 to the SDD 104, in accordance with the BDF protocol. In still another aspect, to facilitate desired transmission, transmission at the SRS 106 can be given a higher priority, wherein, for example, the SRS 106 can transmit a packet (e.g., copy of the corresponding version of the packet) to the SDD 104 whenever the R-D link is identified as not being blocked, in accordance with the predefined relay criteria. If the R-D link is identified as blocked, the CRCM component 112 can refrain from forwarding the corresponding version of the packet to the SDD 104 during such period of time the R-D link is blocked, in accordance with the BDF protocol.

When the SRS 106 forwards the copy of the corresponding version of the packet to the SDD 104, the SDD 104 can receive the copy of the corresponding version of the packet from the SRS 106. In one aspect, the SDD 104 can include a communication management component 120 that can facilitate communication, including communications involving cognitive relay, between the SSD 102 and/or SRS 106. During this time, in accordance with various embodiments, the SRS 106 can retain the corresponding version of the packet in its queue component 118 (while the SSD 102 already can have removed the corresponding original packet from its queue component 116 in response to the ACK received from the SRS 106), or the SSD 102 and SRS 106 can retain their respective corresponding packets (e.g., corresponding original packet, corresponding version of the packet (e.g., original packet)) in their respective queue components 116 and 118, until an acknowledgement message is received from the SDD 104, wherein the acknowledgement message from the SDD 104 can indicate the packet has been successfully received by the SDD 104.

In an aspect, upon the SDD 104 receiving the packet, the communication management component 120 can generate, and transmit or broadcast, an acknowledgement message (e.g., ACK) to the SRS 106 and/or SSD 102. In response to receiving the acknowledgement message, in accordance with various embodiments, the CRCM component 112 of the SRS 106 can remove the packet (e.g., the copy of the packet) from the queue component 118, and/or the communication management component 114 of the SSD 102 can remove the packet (e.g., corresponding copy of the packet) from its queue component 116, and a next packet (if any) associated with the communication can be processed for transmission, in accordance with the BDF protocol. In an aspect, the respective queues components 116 and 118 (e.g., packet transmission queues) of the SRS 106 and the SSD 102 can be maintained in a stable condition and/or synchronized condition simultaneously or substantially simultaneously, in accordance with the stability region associated with the cognitive relay system, as more fully disclosed herein, which can facilitate maintaining the system 100 in a stable condition.

In still another aspect, in instances where the CRCM component 112 determines or identifies that the SRS 106 is transmitting on the R-D link and/or the S-R link is blocked, the CRCM component 112 can determine that, at this time, the packet cannot be received by the SRS 106 for relay to the SDD 104, in accordance with the BDF protocol, as more fully disclosed herein. In another aspect, the communication management component 114 of the SSD 102 also can determine or identify instances where the SRS 106 is transmitting on the R-D link and/or the S-R link is blocked, and based at least in part on this, the communication management component 114 can determine that, at this time, the packet cannot be transmitted to the SRS 106 for relay to the SDD 104, in accordance with the BDF protocol, as more fully disclosed herein. In such respective instances, no packet is communicated from the SSD 102 to the SRS 106.

In accordance with various aspects, the communication management component 114 also can identify instances when the SSD 102 can directly transmit a packet to the SDD via the S-D link, and can directly transmit the packet (e.g., a copy of an original packet) from the SSD 102 to the SDD 104, in accordance with a baseline (BL) protocol. For instance, in accordance with the BL protocol, the communication management component 114 can facilitate transmission of the packet to the SDD 104 via the S-D link (e.g., a direct wireless communication connection or channel from the SSD 102 to the SDD 104) if and when the communication management component 114 identifies or determines that the S-D link is not blocked. When the communication management component 114 identifies that the S-D link is blocked, the communication management component 114 can refrain from transmitting the packet via the S-D link, and continues to monitor, obtain and analyze information relating to the respective link statuses of the S-R link, R-D link and S-D link to determine whether to transmit the packet via the SRS 106 to the SDD 104 or transmit the packet directly to the SDD 104.

When the packet is transmitted directly to the SDD 104 from the SSD 102, in response to receiving the packet (e.g., a copy of the original packet maintained in the queue component 116), the communication management component 120 of the SDD 104 can transmit or broadcast an acknowledgement message to the SSD 102 (and/or the SRS 106). In response to receiving the acknowledgement message, the communication management component 114 of the SSD 102 can remove the original copy of the packet from the queue component 116, and a next packet (if any) of the communication can be processed for transmission, in accordance with a specified relay protocol.

In accordance with another embodiment, the system 100 can employ a SDF protocol. When employing the SDF protocol, the CRCM component 112 can identify when the S-R link is not blocked, as more fully disclosed herein. It is noted, that, when using the SDF protocol, it is not necessary for the CRCM component 112 to also determine that the SRS 106 is not transmitting on the R-D link, in contrast to the BDF protocol. In such instance when the S-R link is not blocked, the CRCM component 112 can allow transmission of a packet (e.g., voice or data packet) from the SSD 102 to the SRS 106, in accordance with the SDF protocol.

In accordance with various aspects, the communication management component 114 of the SSD 104 also can receive or obtain information regarding the status of the S-R link and can identify instances when the S-R link is not blocked, as more fully disclosed herein. When the communication management component 114 identifies the S-R link as not being blocked, the communication management component 114 can determine that the first or next packet in the queue component 116 can be communicated to the SRS 106, and the communication management component 114 can facilitate transmission of that packet (e.g., a corresponding copy of the original packet) to the SRS 106.

The SRS 106 can receive the packet (e.g., copy of the original packet), and the CRCM component 112 can decode or otherwise process the packet to obtain or derive the voice or data information contained in the packet, and can encode (e.g., re-encode) and otherwise process the voice or data information to generate a corresponding version of the packet, and insert or store the corresponding version of the packet in the queue component 118. In another aspect, the SRS 106 will not receive another packet from the SSD 102 relating to a particular communication before the current packet has been successfully forwarded to the SDD 104.

In accordance with various embodiments, in response to successfully receiving the packet from the SSD 102, the CRCM component 112 also can transmit an acknowledgement message to the SSD 102 to notify the SSD 102 that the packet was successfully received by the SRS 106. In one embodiment, in response to receiving that acknowledgement message, the communication management component 114 of the SSD 102 can remove the corresponding original packet from its queue component 116. In accordance with alternative embodiments, the communication management component 114 of the SSD 102 can maintain the knowledge that the packet was received by the SRS 106 so that the SSD 102 does not attempt to re-send the packet to the SRS 106 or directly to the SDD 104 and can continue to maintain the corresponding original packet in the SSD queue component 116 until an acknowledgement message is received from the SDD 104 to indicate that the SDD 104 has successfully received the packet (e.g., a copy of the corresponding version of the packet), or the communication management component 114 of the SSD 102 can move the corresponding original packet from the SSD queue component 116 to another queue component or a data store while awaiting an acknowledgement message, which indicates the packet (e.g., copy of a corresponding version of the packet) was received by the SDD 104, from the SDD 104, and the communication management component 114 can remove the original packet from the queue component 116, other queue component, or data store, in response to receiving the acknowledgement message from the SDD 104.

In accordance with still another aspect, in accordance with the SDF protocol, the CRCM component 112 can forward (e.g., transmit) the corresponding version of the packet from the queue component 118 of the SRS 106 to the SDD 104, for example, in accordance with known decode-and-forward techniques. As disclosed, during the time of communication of the packet, the SSD 102 and/or SRS 106 can retain the packet (e.g., respective copies of the packet) in their respective queue components 116 and 118, until an acknowledgement message is received from the SDD 104, wherein the acknowledgement message can indicate the packet has been successfully received by the SDD 104. In an aspect, upon the SDD 104 receiving the packet, the communication management component 120 can generate, and transmit or broadcast, an acknowledgement message (e.g., ACK) to the SRS 106 and/or SSD 102. In response to receiving the acknowledgement message, in accordance with various embodiments, as disclosed herein, the CRCM component 112 can removed the corresponding version of the packet from its queue component 118 and/or the communication management component 114 of the SSD 102 can remove the packet from its queue component 116. At this point, a next packet (if any) associated with the particular communication can be processed for transmission, in accordance with the SDF protocol (or another desired relay protocol). In an aspect, the queue component 116 of the SSD 102 can be maintained in a stable condition, in accordance with the stability region associated with the CRS, as more fully disclosed herein, which can facilitate maintaining the system 100 in a stable condition.

In still another aspect, the CRCM component 112 of the SRS 106 and the communication management component 114 of the SSD 102 each can identify in instances when the S-R link is blocked. In such an instance, the CRCM component 112 and communication management component 114 can respectively determine that a packet is not to be transmitted via the SRS 106 (at least at this time), in accordance with the SDF protocol. As more fully disclosed herein, the communication management component 114 of the SSD 102 can identify instances where a packet can be transmitted directly to the SDD 104 via the S-D link, in accordance with the BL protocol.

It is to be appreciated and understood that, while the BDF, SDF, and BL protocols generally have been described separately herein with regard to various embodiments, the disclosed subject matter is not so limited, as the BDF, SDF, and/or BL protocols can be employed concurrently, or otherwise in a hybrid fashion, to facilitate communications, including communications involving cognitive relay, between the SSD 102 and SDD 104. Further, in another aspect, the CRCM component 112, communication management component 114, and/or communication management component 120 can dynamically change between the respective protocols, such as BDF, SDF, and/or BL protocols, in accordance with the predefined relay criteria. For instance, the system 100 can be structured to transmit packets directly from the SSD 102 to the SDD 104 via the S-D link, in accordance with the BL protocol, and, concurrently, whenever a packet can be transmitted from the SSD 102 to the SRS 106 for forwarding to the SDD 104 by the SRS 106, the SSD 102 can transmit that packet (e.g., a copy of the packet) to the SRS 106, which can forward that packet (e.g., a corresponding version of that packet) to the SDD 104, in accordance with the BDF or SDF protocol.

It is to be appreciated and understood that the respective number of components or devices of the system 100 are example numbers, and the disclosed subject matter is not so limited, as, in accordance with various embodiments, with regard to the respective components or devices, there can be more or less components or devices than that depicted or described with regard to the system 100. It is to be further appreciated and understood that, in accordance with various embodiments, a component of the system 100, respectively, can be a stand-alone unit, or can be part of another component in system 100, or portions (e.g., components) of such component can be distributed as separate components throughout the system 100, as desired.

In accordance with an embodiment of the disclosed subject matter, one or more components (e.g., SSD 102, SDD 104, SRS 106, CRCM component 112, communication management component 114, communication management component 120, etc.) in a communication network can utilize artificial intelligence (AI) techniques or methods to infer (e.g., reason and draw a conclusion based at least in part on a set of metrics, arguments, or known outcomes in controlled scenarios) an action to perform (e.g., automatically or dynamically) in response to the inference; whether an S-R link, R-D link and/or S-D link is blocked at a given time; whether the respective queues 116 and 118 are simultaneously in a stable condition; whether a communication device (e.g., primary communication device 108 or 110) associated with the primary communication system is currently communicating via the primary communication system; whether to utilize the BDF protocol, SDF protocol, or BL protocol at a given time; etc. Artificial intelligence techniques typically can apply advanced mathematical algorithms—e.g., decision trees, neural networks, regression analysis, principal component analysis (PCA) for feature and pattern extraction, cluster analysis, genetic algorithm, and reinforced learning—to historic and/or current data associated with system 100 (or another system(s) or method(s) disclosed herein) to facilitate rendering an inference(s) related to the system 100 (or another system(s) or method(s) disclosed herein).

In particular, the one or more components in the network can employ one of numerous methods for learning from data and then drawing inferences from the models so constructed, e.g., Hidden Markov Models (HMMs) and related prototypical dependency models. General probabilistic graphical models, such as Dempster-Shafer networks and Bayesian networks like those created by structure search using a Bayesian model score or approximation can also be utilized. In addition, linear classifiers, such as support vector machines (SVMs), non-linear classifiers like methods referred to as “neural network” methods, fuzzy logic methods can also be employed. Moreover, game theoretic models (e.g., game trees, game matrices, pure and mixed strategies, utility algorithms, Nash equilibria, evolutionary game theory, etc.) and other approaches that perform data fusion, etc., can be exploited in accordance with implementing various automated aspects described herein. The foregoing methods can be applied to analysis of the historic and/or current data associated with system 100 (or another system(s) disclosed herein) to facilitate making inferences or determinations related to system 100 (or another system(s) disclosed herein).

In accordance with various aspects and embodiments, the disclosed subject matter can be utilized in wireless and/or wired communication networks. For instance, the disclosed subject matter can be employed in virtually any communication network where more than one component can be communicating with a communication device at the same or substantially the same time and such components also are subjected to respective load levels on respective links with a controller component due to communications with communication devices. For example, the disclosed subject matter can be employed in wireless networks, such as wireless networks that employ soft handover of communication devices (e.g., UE), with such networks including, for example, Third Generation (3G) type networks, Fourth Generation (4G) type networks, Universal Mobile Telecommunications Systems (UMTS), Code Division Multiple Access (CDMA) type systems, Wideband CDMA (WCDMA) type systems, etc.

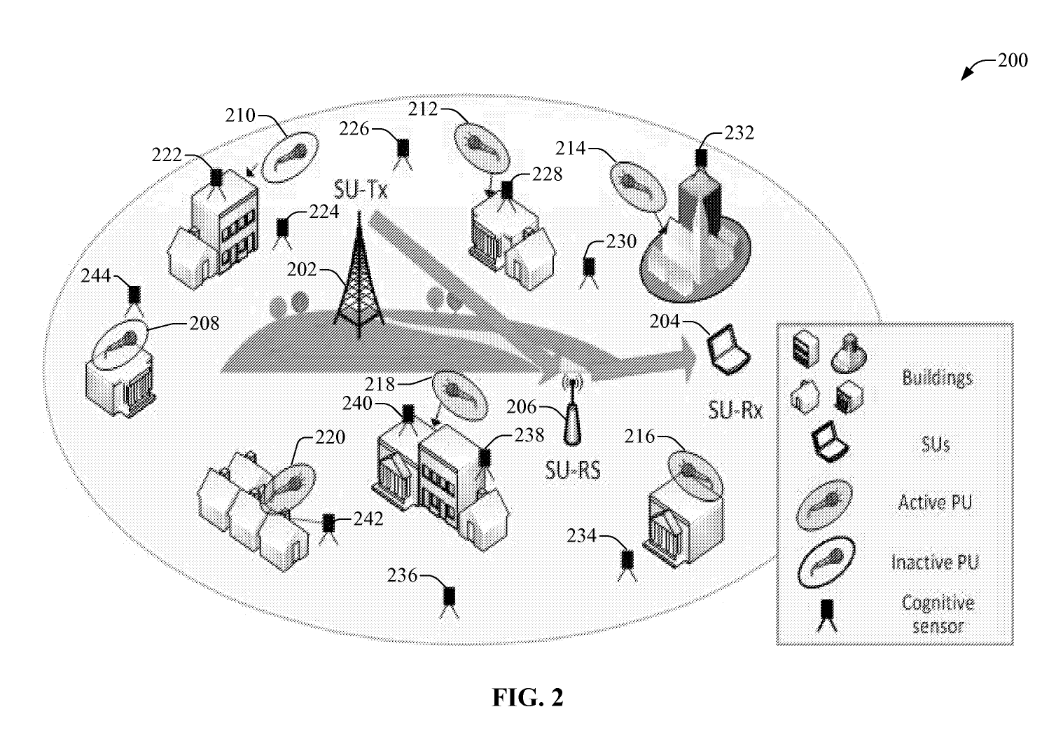

FIG. 2 depicts a diagram of an example system 200 that can facilitate communications using cognitive relay in accordance with various aspects and embodiments of the disclosed subject matter. In accordance with various aspects, the system 200 can be a large-coverage CRS that can access the licensed spectrum of one or more randomly distributed small-coverage PU systems. For example, the system 200 can comprise a CR network that is a WRAN system covering a suburb college town or a rural area, wherein there can be cell radius ranges of 2 to 10 kilometers or even larger.

The system 200 can include a SSD 202 (e.g., base station) (also referred to as secondary user transmitter (SU-Tx)), SDD 204 (e.g., mobile communication device) (also referred to as secondary user receiver (SU-Rx)), and SRS 206 (e.g., relay station) (also referred to as secondary relay station (SU-RS)), and a plurality of primary communication devices, including primary communication devices 208, 210, 212, 214, 216, 218 and 220, wherein each of the SSD 202, SDD 204, SRS 206, and primary communication devices (e.g., 208 through 220) (also referred to as PUs), respectively, can be the same as or similar to, or can comprise the same or similar functionality as, respective components (e.g., respectively named components), as disclosed herein. In an embodiment, one or more of primary communication devices can have a relatively small transmission range (e.g., 100 to 200 meters), wherein there is the potential for a pair of SU nodes (e.g., SSD, SDD) to affect one or more PU systems simultaneously. As shown in FIG. 2, certain of the primary communication devices (e.g., 212, 214, 216, 218, 220) can be in active mode (e.g., actively communicating in the primary communication system (also referred to as PU system)) and other of the primary communication devices (e.g., 208, 210) can be in inactive mode (e.g., not actively communicating in the PU system) at a given time, although at other given times, the respective PUs can be in active or inactive modes depending on whether the respective PUs are attempting to communicate data or not. In accordance with various aspects, the SRS 206 can be employed to facilitate communication between a primary communication device (e.g., 212) and another primary communication devices (e.g., 214) (e.g., via wireless communication connections), or can facilitate communication between only the SRS 206 and a primary communication device (e.g., 212) (e.g., wherein the SRS 206 can communicate voice or data via a wireline communication connection).

In accordance with another aspect, the system 200 can include a plurality of sensors (e.g., cognitive sensors), such as sensors 222, 224, 226, 228, 230, 232, 234, 236, 238, 240, 242 and 244, wherein the sensors 222 through 244 can sense conditions (e.g., sense whether a PU is actively communicating or not) or information (e.g., information relating to or indicating an activity state of a PU) relating to respective transmissions associated with the respective primary communication devices (e.g., 212, 214, 216, 218, 220). As depicted in FIG. 2, the sensors can be distributed, as desired, throughout the coverage area (e.g., large-coverage area of the CRS). For instance, as shown in FIG. 2, the various sensors are placed in or near buildings or other areas wherein a primary communication device may communicate.

The SSD 202 (e.g., via the communication management component) and SRS 206 (e.g., via the CRCM component) can monitor the coverage area, including the sensors (e.g., 222 through 244) in the coverage area, and can receive, detect, or obtain information from one or more of the sensors 222 through 244. The SSD 202 and SRS 206 respectively can identify a current activity state of one or more of the primary communication devices (e.g., 212 through 220) at a given time. Identification of the current activity state of the one or more of the primary communication devices (e.g., 212 through 220) at a given time can enable the SSD 202 and SRS 206 to identify whether a transmission of a packet by an SSD 202 to an SDD 204 via the SRS 206 (e.g., transmission of a packet from SSD 202 to SRS 206, transmission of a packet from SRS 206 to SDD 204) is blocked at that given time. It is noted that, if and when SDD 204 is preparing to transmit packets to the SSD 202, the SDD 204 can monitor the coverage area, including the sensors (e.g., 222 through 244) in the coverage area, and can receive, detect, or obtain information from one or more of the sensors 222 through 244, and can identify a current activity state of one or more of the primary communication devices (e.g., 212 through 220) at a given time to facilitate identifying whether a transmission of a packet by the SDD 204 to the SSD 202 via the SRS 206 (e.g., transmission of a packet from SDD 204 to SRS 206, transmission of a packet from SRS 206 to SSD 202) is blocked at a given time.

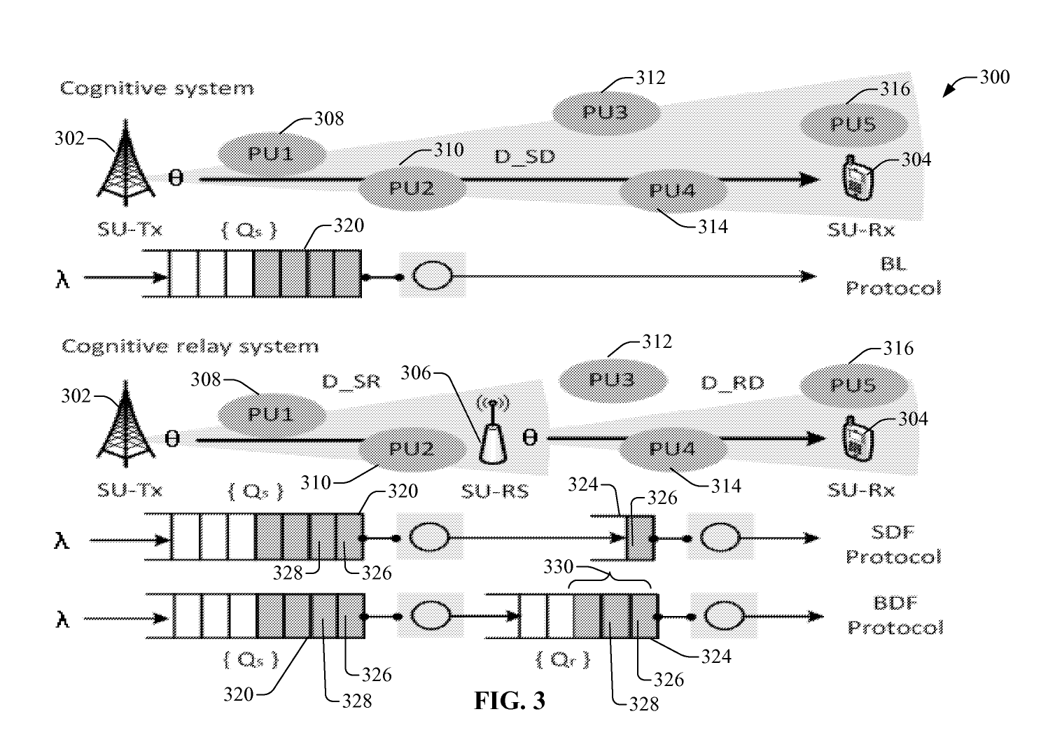

Referring briefly to FIG. 3, illustrated is a diagram of example systems 300 comprising a cognitive system and a CR system that can utilize a desired relay protocol in accordance with various aspects and embodiments of the disclosed subject matter. The system 300 can include a SSD 302 (e.g., base station) (also referred to as secondary user transmitter (SU-Tx)), SDD 304 (e.g., mobile communication device) (also referred to as secondary user receiver (SU-Rx)), and SRS 306 (e.g., relay station) (also referred to as secondary relay station (SU-RS)), and a plurality of primary communication devices, including primary communication devices 308 (PU1), 310 (PU2), 312 (PU3), 314 (PU4), and 316 (PU5), wherein each of the SSD 302, SDD 304, SRS 306, and primary communication devices (e.g., 308 through 316), respectively, can be the same as or similar to, or can comprise the same or similar functionality as, respective components (e.g., respectively named components), as disclosed herein.

With regard to the cognitive system 318, the SSD 302 can include queue component 320 that can store one or more packets for transmission to a desired destination, such as the SDD 304. When the cognitive system 318 is employed, the SSD 302 can transmit one or more packets to the SSD 304, in accordance with the BL protocol (e.g., when the S-D link is not blocked), as disclosed herein. When a packet is transmitted to and received by the SDD 304, the packet can be removed from the queue component 320, in response to an acknowledgement message received by the SSD 302 from the SDD 304, the SSD 302 can remove that packet from the queue component 320.

With regard to the CRS 322, the SSD 302 can include queue component 320 that can store one or more packets for transmission to a desired destination, such as the SDD 304. The SRS 306 can include a queue component 324 that can store one or more packets received from the SSD 302 for forwarding to the SDD 304, as more fully disclosed herein. When the CRS 322 is employed, the SSD 302 can transmit one or more packets to the SSD 304, in accordance with the SDF protocol (e.g., the SRS 306 can receive a packet from the SSD 302 when the S-R link is not blocked, and can forward the packet to the SDD 304 using known decode-and-forward techniques), or in accordance with the BDF protocol (e.g., the SRS 306 can receive a packet from the SSD 302 when the S-R link is not blocked and the SRS 306 is not transmitting on the R-D link, and can forward the packet to the SDD 304 when the R-D link is not blocked), as more fully disclosed herein. When a packet is transmitted to and received by the SDD 304, the packet can be removed from the queue component 320, in response to an acknowledgement message received by the SSD 302 from the SDD 304, the SSD 302 can remove that packet from the queue component 320.

As depicted in FIG. 3, in accordance with the SDF protocol, the queue component 324 typically can include up to one packet 326, as the SRS 306 is not able to receive a new or next packet 328 from the SSD 302 until the current packet 326 has been successfully forwarded to the SDD 304. In accordance with the BDF protocol, the queue component 324 typically can include a subset of packets 330 (e.g., one or more packets), as the SRS 306 is able to receive a packet (e.g., 326, 328) from the SSD 302 when the SRS 306 is not transmitting to the SDD 304 on the R-D link and the S-R link is not blocked.

In accordance with various aspects and embodiments, in order to facilitate reducing the interference region that can be caused by SU transmission, the SSD 302 and SRS 306 each can comprise antenna arrays, including a specified number of antennas, that can be equipped for beamforming, with bandwidth θ and transmit antenna gain Gₜ. Since the SRS 306 can operate in half-duplex mode, the SRS 306 can use the antenna ray to facilitate obtaining the receiving antenna gain Gᵣ. In an embodiment, the SDD 304 can employ one omnidirectional antenna. In an aspect, the transmission time of the system 300 can be slotted, as disclosed herein.

Referring again to FIG. 2, along with FIG. 3, the disclosed subject matter illustrates a scenario where the coverage of the secondary user system (SU system) is much larger than that of the primary user systems (PU systems). One example of such CR network is the Wireless Regional Area Network (WRAN) system covering a suburb college town or rural areas, which can be represented in FIG. 2, whose cell radius can range from 2 through 10 kilometers or even larger. The PU systems inside can be, for example, Part74 devices (e.g., wireless microphones), whose transmission ranges typically are about 100 through 200 meters. So the transmission between a pair of SU nodes potentially may affect multiple PU systems simultaneously.

In accordance with the disclosed subject matter, there can be a CRS with a SU transmitter (SU-Tx) (e.g., 302), a SU receiver (SU-Rx) (e.g., 304), and a half-duplex cognitive RS (SU-RS) (e.g., 306), as shown in FIG. 3. The link between SU-Tx and SU-Rx can be the S-D link (also referred to as SD or D_SD), the link between SU-Tx and SU-RS can be the S-R link (also shown as SR or D_SR), and the link between SU-RS and SU-Rx can be the R-D link (also referred to as RD or D_RD). In an embodiment, in order to reduce the interference region caused by SU transmission, antenna arrays can be equipped at both SU-Tx and SU-RS for beamforming with beamwidth θ and transmit antenna gain Gₜ. Since SU-RS can operate in half-duplex mode, it can utilize the antenna array to obtain receiving antenna gain Gᵣ. In an embodiment, at SU-Rx, there can be one omnidirectional antenna available. In an aspect, the transmission time of the CRS can be slotted. In any slot, using power Pᵢⱼ to transmit signal X (with unit signal energy) on link ij, the received signal at j is

$${Y}_{j} = \{ \begin{matrix}a ( {P}_{ij} ) {h}_{ij} \sqrt{{P}_{ij} {L}_{ij} {G}_{i}} X + {I}_{j} + {Z}_{j} , & i = S , R , j = D \\ a ( {P}_{ij} ) {h}_{ij} \sqrt{{P}_{ij} {L}_{ij} {G}_{i} {G}_{r}} X + {I}_{j} + {Z}_{j} , & i = S , j = R\end{matrix}$$

respectively, where a(Pᵢⱼ) is an indicatior variable and is a function of Pᵢⱼ. This indicator variable can indicate whether the transmission from i to j using power Pᵢⱼ is blocked by any PU, a(Pᵢⱼ)=0 can indicate the transmission is blocked on the ij link and a(Pᵢⱼ)=1 can indicate that the transmission is not blocked on the ij link. hᵢⱼ can represent the channel fading coefficient, which can be assumed to be flat Rayleigh so that the power gain on the link ij, e.g., Hᵢⱼ=|hᵢⱼ|², is exponentially distributed with parameter 1. Hᵢⱼ can be assumed to be quasi-static within a slot but identically and independently distributed (i.i.d) between different slots. Lᵢⱼ=κ₀·Dᵢⱼ^{-α} is the large-scale path-loss between i and j, where Dᵢⱼ is the distance between i and j, κ₀ and α are path-loss coefficient and exponent, respectively. Iⱼ can represent the sum signals received from all neighboring active PUs at node j. Since the PU's coverage is much smaller and it is assumed SU-Rx is not inside the coverage of any active PU, Iⱼ can be treated as white noise with power [symbol] [Iⱼ]=σ_{I}², ∀j. Zⱼ is the white Gaussian noise at receiver j, e.g., Zⱼ˜ [symbol] (0, σⱼ²) and it can be assumed that σⱼ¹=σ², ∀j. The instantaneous received signal-to-interference-and-noise ratio (SINR) on link ij can be defined as

$${γ}_{ij} = a ( {P}_{ij} ) \cdot {C}_{0} \cdot \frac{{p}_{ij}}{{D}_{ij}^{a}} \cdot {H}_{ij} , j = D$$

$$and$$

$${γ}_{SR} = a ( {P}_{SR} ) \cdot {C}_{0} {G}_{r} \cdot \frac{{P}_{SR}}{{D}_{SR}^{a}} \cdot {H}_{SR} ,$$

respectively, where

$${C}_{0} = \frac{{κ}_{0} {G}_{t}}{{σ}^{2} + {σ}_{i}^{2}}$$

is a constant independent of the transmit power. Moreover, the maximum transmit power constraint for SU-Tx and SU-RS can both be, or can be assumed to be, Pₘₐₓ respectively.

For purposes of describing various aspects of the disclosed subject matter, the PUs can be uniformly and/or randomly distributed on the two-dimensional plane with density ρ. In any given slot, each PU can be either active (ON) (with probability π₁) or inactive (OFF) (with probability πn₀=1−π₁). By the indicator variable a(Pᵢⱼ), the disclosed subject matter can relate the impact of PU activities to received SINRs on link ij. When transmitting with power the average interference-to-noise ratio (INR) received by a PU D_{SP} distance away can be

$${\overline{γ}}_{SP} ( {P}_{ij} , {D}_{SP} ) = {C}_{0} \cdot \frac{{P}_{ij}}{{σ}_{P}^{2} {D}_{SP}^{α}} .$$

When the INR is higher than threshold γth, the PU transmission will be interfered. Setting γSP(Pᵢⱼ, D_{SP}*)=γth, the radius of the maximum interference region can be determined as

$${D}_{SP}^{*} = {( \frac{{C}_{0}}{{σ}_{P}^{2} {γ}_{th}} \cdot {P}_{ij} )}^{1 / α} .$$

Since the directional beam with beamwidth θ rad can be approximated by a sector with angle

$$\frac{θ}{2 π} ,$$

the area of the interference region can be approximated by the area of that sector with radius D_{SP}*, which is

$${A}_{SP} ( {P}_{ij} ) = π {D}_{SP}^{* 2} \cdot \frac{θ}{2 π} .$$

According to the uniform distribution assumption, the average number of PUs in the interference region can thus be calculated as N(Pᵢⱼ)=ρ·A_{SP}(Pᵢⱼ). The SU transmission on link ij is “blocked” if any of the N(Pᵢⱼ) PUs is active and a(Pᵢⱼ)=0. Recall Sₖ is the activity state of the k-th PU in the region and the probability that the SU transmission with power Pᵢⱼ would not be blocked is

$$Pr \{ a ( {P}_{ij} ) = 1 \} = {π}_{0}^{N ( {P}_{ij} )} = exp \{ - {C}_{1} ( ρ , {π}_{0} ) \cdot {P}_{ij}^{2 / α} \}$$

$$where$$

$${C}_{1} ( ρ , {π}_{0} ) = \frac{ρθ}{2} {( \frac{{C}_{0}}{{σ}_{P}^{2} {γ}_{th}} )}^{2 / α} ln \frac{1}{{π}_{0}} > 0$$

is a constant independent of the transmit power Pᵢⱼ but is directly related to the PU distribution density ρ and activity intensity π₀.

The probability of successful transmission over a link can now be considered. In an aspect, the data of the SU system can be encapsulated into small packets with M bits each. For each time slot, at most one packet can be transmitted, which requires channel capacity larger than M. Using Shannon formula, the channel capacity between node i and j can be expressed as Φᵢⱼ=B log₂(1+γᵢⱼ), where B is the bandwidth of the channel and γᵢⱼ is the SINR at receiver j. Thus, the probability of successful transmission of a packet over link ij, denoted as pᵢⱼ^{succ}, is

$${p}_{ij}^{succ} ( {P}_{ij} ) = Pr \{ B {log}_{2} ( 1 + {γ}_{ij} ) > M \} = Pr \{ {H}_{ij} > \frac{( {2}^{M / B} - 1 ) {D}_{ij}^{α}}{{C}_{0} {P}_{ij}} \} \cdot Pr \{ a ( {P}_{ij} ) = 1 \} {=}^{( 1 )} exp \{ - {C}_{1} ( ρ , {π}_{0} ) \cdot {P}_{ij}^{2 / α} - {C}_{2} ( M / B , {D}_{ij} ) \cdot {P}_{ij}^{- 1} \} , \qquad ( 1 )$$

For i=S, R, j=D, where

$${C}_{2} ( M / B , {D}_{ij} ) = \frac{( {2}^{M / B} - 1 )}{{C}_{0}} \cdot {D}_{ij}^{α} > 0$$

is a constant independent of Pᵢⱼ but directly related to the ratio of packet size over the channel bandwidth M/B and the distance between the two ends of the link Dᵢⱼ. Act (1) is from equation (1). For the case j=R,

$${p}_{SR}^{succ} ( {P}_{SR} ) = exp \{ - \frac{{C}_{1} ( ρ , {π}_{0} )}{{P}_{SR}^{- 2 / α}} - \frac{{C}_{2} ( \frac{M}{B} , {D}_{SR} )}{{G}_{r} {P}_{SR}} \} . \qquad ( 2 )$$

Property 1: For a given set of dᵢⱼ, R, ρ, and π₀, there can exist a unique transmit power Pᵢⱼ^{opt}>0 that can maximize the probability of successful transmission over link ij, e.g., ∃Pᵢⱼ^{opt}, s.t, Pᵢⱼ^{opt}=arg max pᵢⱼpᵢⱼ^{succ}(Pᵢⱼ). The optimal transmit power for SD, SR and RD links (in the interference limited case, e.g., Pᵢⱼ^{opt}<Pₘₐₓ) are (i=S,R)

$${P}_{iD}^{opt} = {( \frac{α {C}_{2} ( \frac{M}{B} , {D}_{iD} )}{2 {C}_{1} ( ρ , {π}_{0} )} )}^{\frac{α}{α + 2}} \\ {P}_{SR}^{opt} = {( \frac{α {C}_{2} ( \frac{M}{B} , {D}_{SR} )}{2 {G}_{r} {C}_{1} ( ρ , {π}_{0} )} )}^{\frac{α}{α + 2}} \qquad ( 3 )$$

respectively, and the maximized probabilities of successful transmission on SD, RD and SR links can be (i=S,R)

$$\begin{matrix}{p}_{iD}^{succ , opt} = exp \{ - {C}_{3} {C}_{1}^{\frac{α}{α + 2}} ( ρ , {π}_{0} ) {C}_{2}^{\frac{2}{α + 2}} ( \frac{M}{B} , {D}_{iD} ) \} & ( 4 ) \\ {p}_{SR}^{succ , opt} = exp \{ - \frac{{C}_{3}}{{G}_{r}^{\frac{2}{α + 2}}} {C}_{1}^{\frac{α}{α + 2}} ( ρ , {π}_{0} ) {C}_{2}^{\frac{2}{α + 2}} ( \frac{M}{B} , {D}_{SR} ) \} \\ where {C}_{3} = ( 1 + \frac{α}{2} ) {( \frac{α}{2} )}^{- \frac{α}{α + 2}} & ( 5 )\end{matrix}$$

is a constant related to α.

For each protocol (e.g., BDF, SDF, BL), a sufficiently large buffer (e.g., a virtually infinitely long buffer) can be employed in the SU-Tx (e.g, 202, 302), wherein, in an embodiment, the buffer can be a queue component, such as a FIFO queue, that applies the FIFO rule. The transmission time can be slotted and the packet transmission can start at the beginning of a slot. In each slot, only one packet can be transmitted. When transmitting, SU-Tx and SU-RS (e.g., 206, 306) can use the optimal transmit power to maximize the probability of successful transmission over a link.

In accordance with the BL protocol, the SU-Tx can transmit a packet (e.g., a corresponding copy of an original packet) directly to the SU-Rx if the S-D link is not blocked. The packet (e.g., original packet) can be removed from the queue component of the SU-Tx when an acknowledge (ACK) message is received from SU-Rx.

In accordance with the SDF protocol, the SU-RS can successfully receive a packet (e.g., a corresponding copy of an original packet stored in the queue component of the SU-Tx) from the SU-Tx if the S-R link is not blocked. The SU-RS can decode the received packet and forward a corresponding version of the received packet (e.g., re-encoded packet) to the SU-Rx in accordance with known decode-and forward (DF) relay techniques. The SU-RS cannot receive a new or next packet from the SU-Tx before the packet currently held by the SU-RS has been successfully forwarded to the SU-Rx. A packet can be removed from the queue component of the SU-Tx when an ACK is received from the SU-Rx.

With regard to the BDF protocol, a sufficiently large buffer (e.g., a virtually infinitely long buffer) can be employed in the SU-RS, wherein, in an embodiment, the buffer can be a queue component, such as a FIFO queue, that applies the FIFO rule. In accordance with the BDF protocol, the SU-Tx can transmit a packet to the SU-RS only when SU-RS is not transmitting on the R-D link and the S-R link is not blocked. The packet (e.g., original packet) can be removed from the queue component of the SU-Tx if an ACK is received from the SU-RS. In an aspect, a higher transmission priority can be employed at the SU-RS such that the SU-RS can transmit the packet (e.g., a copy of a corresponding version of the packet) to the SU-Rx whenever the R-D link is not blocked. In another aspect, the SU-RS can have or receive channel state information (CSI) of the R-D link so that the channel outage time of the R-D link can be further saved for SR link transmission. The packet (e.g., corresponding version of the original packet) can be removed from the queue component of the SU-RS when an ACK is received from the SU-Rx.

In looking at queue dynamics of the respective queue components of the SU-Tx and SU-RS, a desired model can be used to depict the buffer dynamics in a slotted system, as disclosed herein. In an aspect, Q_{S}(t), t=mρ, m=0, 1, . . . can denote the queue length at the SU-Tx observed at the end of slot t. It can evolve as Q_{S}(t)=(Q_{S}(t−1−Y_{S}(t))⁺+X_{S}(t)ₜ∀t. In this equation, X_{S}(t) can represent the number of packet arrivals in slot t (respective packets cannot be transmitted in the same slot), which can be assumed to be a Bernoulli process with mean [symbol] [X_{S}(t)]=λ, e.g., X_{S}(t) only takes value 0 or 1 with probability 1−λ and λ, respectively. Y_{S}(t) can denote the number of packets that depart from SU-Tx in slot t. According to the protocols, Y_{S}(t) also takes value from (0, 1), depending at least in part on the states of PU activities, channel fading, and the interaction with the queue dynamics of the queue component of the SU-RS. Since Q_{S}(t+1) only depends on Q_{S}(t) and X_{S}(t),Y_{S}(t) is either 0 or 1, {Q_{S}} can be a discrete time Markov Chain and its state transitions only happen between neighboring states, e.g., {Q_{S}} can be a discrete time birth-death process (DTBDP). For n≧0, let λ_{S}ⁿ be the state transition probabilities from Q_{S}(t)=n to Q_{S}(t+1)=n+1 and μ_{S}ⁿ the state transition probabilities from Q_{S}(t)=n to Q_{S}(t+1)=n−1 for n≧1. Similarly, the evolution for the queue component at SU-RS can be defined as Q_{R}(t)=(Q_{R}(t−1)−Y_{R}(t))⁺+X_{R}(t), ∀t. Note the arrival process X_{R}(t) depends at least in part on the departure process of the source queue component (e.g., Y_{S}(t)) and the half-duplex constraint can make the interaction between Q_{S}(t) and Q_{R}(t) relatively complicated. {Q_{R}} also can be a DTBDP, whose state transition probabilities can be defined in a similar manner as λ_{R}ⁿ and μ_{R}ⁿ, respectively.

A queue Qᵢ a can be stable if (e.g., if and only if) lim_{t→∞}Pr{Qᵢ(t)=0}>0, for i=S, R. In the BL and SDF protocols, when the queue at SU-Tx is stable, the whole system (e.g., system 100, system 200, system 300) can be stable, but in the BDF protocol, system stability requires both the queue component of the SU-Tx and the queue component of the SU-RS to be stable simultaneously. λ* can denote the stability region of the CRS in terms of the maximum exogenous arrival rate, which has unit “packet/slot”.

The end-to-end delay of a packet in the CRS can be the time from a packet arrives at the queue component of the SU-Tx till the packet reaches the SU-Rx. Little's theorem enables the study from the angle of average queue length. Given the exogenous arrival rate λ, the average end-to-end delay for the three protocols can be defined as (unit: slots)

$$\begin{matrix}{\overline{W}}_{BL} = \frac{1}{λ} {lim}_{T -> ∞} \frac{{\sum }_{i = 1}^{T} {Q}_{S} ( t )}{T} = \frac{𝔼 [ {Q}_{S} ]}{λ} , & ( 6 ) \\ {\overline{W}}_{SDF / BDF} = \frac{1}{λ} {lim}_{T -> ∞} \frac{{\sum }_{t = 1}^{T} {Q}_{S} ( t )}{T} + \frac{1}{λ} {lim}_{T -> ∞} \frac{{\sum }_{t = 1}^{T} {Q}_{R} ( t )}{T} \\ = \frac{𝔼 [ {Q}_{S} ] + 𝔼 [ {Q}_{R} ]}{λ} & ( 7 )\end{matrix}$$

where [symbol] is taken with regard to the steady distribution of queue length of the queue component of the SU-Tx.

In the BL protocol, only {Q_{S}} is involved. The queue length of the queue component increases by one if a new packet arrives and no packet has been successfully transmitted, and decreases by one if an existing packet is successfully transmitted and no new packet has arrived, which implies λ_{S}ⁿ⁼⁰=λ and λ_{S}^{n≧1}=λ·(1−p_{SD}^{succ,opt}), and μ_{S}^{n≧1}=(1−λ)·p_{SD}^{succ,opt}. The stable distribution of {Q_{S}} can be derived by solving the detailed balance equation related to the DTBDP. q_{S}ⁿ can be defined as Pr[Q_{S}=n], and

$$\begin{matrix}{q}_{S}^{0} = {( 1 + {\sum }_{n = 1}^{∞} {\prod }_{k = 0}^{n - 1} \frac{{λ}_{S}^{k}}{{μ}_{S}^{k + 1}} )}^{- 1} = 1 - \frac{λ}{{p}_{SD}^{succ , opt}} , & ( 8 ) \\ {q}_{S}^{n} = {q}_{S}^{0} {\prod }_{k = 0}^{n - 1} \frac{{λ}_{S}^{k}}{{μ}_{S}^{k + 1}} = \frac{{q}_{S}^{0}}{1 - {p}_{SD}^{succ , opt}} {( \frac{λ ( 1 - {p}_{SD}^{succ , opt} )}{( 1 - λ ) \cdot {p}_{SD}^{succ , opt}} )}^{n} & ( 9 )\end{matrix}$$

System stability requires q_{S}⁰>0, which implies λ*=p_{SD}^{succ,opt}. Furthermore, the end-to-end delay can be calculated as according to Equation (6). Theorem 1 summarizes the above results.

Theorem 1: The stability region and the average end-to-end delay under the BL protocol are

λ_{BL}*=p_{SD}^{succ,opt}, W̅_{BL}=(1−λ)/(p_{SD}^{succ,opt}−λ) (10)

In the following, a general case of SU-RS having buffer length L can first be analyzed. Similar as in the BL protocol, the decrease in the number of packets of the queue component, Q_{S}, implies a packet has been successfully transmitted to the SU-RS and no new packet arrives. However, under the SDF or BDF protocol, the departure process of Q_{S}(t) is related to the dynamics of Q_{R}(t). The state transition probabilities are

$$\begin{matrix}{μ}_{S}^{n \geq 1} = ( 1 - λ ) Pr ( ɛ \{ SR link successful \} ) \times \\ Pr ( ɛ \{ RD link idle \} \vert ɛ \{ {Q}_{R} \neq L \} ) Pr ( ɛ \{ {Q}_{R} \neq L \} ) \\ = ( 1 - λ ) [ {q}_{R}^{0} + ( 1 - {q}_{R}^{0} - {q}_{R}^{L} ) ( 1 - {p}_{RD}^{succ} ) ] {p}_{SR}^{succ , opt}\end{matrix}$$

$${λ}_{S}^{n \geq 1} = λ \{ 1 - [ {q}_{R}^{0} + ( 1 - {q}_{R}^{0} - {q}_{R}^{L} ) ( 1 - {p}_{RD}^{succ} ) ] {p}_{SR}^{succ , opt} \}$$

and λ_{S}ⁿ⁼⁰=λ. Using the same technique as used in obtaining the result for Equation (8), the steady state probability of Q_{S}=0 is

$${q}_{S}^{0} = 1 - \frac{λ}{[ {q}_{R}^{0} + ( 1 - {q}_{R}^{0} - {q}_{R}^{L} ) ( 1 - {p}_{RD}^{succ} ) ] {p}_{SR}^{succ , opt}} \qquad ( 11 )$$

which implies the stability region is

λ*=[q_{R}⁰+(1−q_{R}⁰−q_{R}^{L}(1−p_{RD}^{succ})]p_{SR}^{succ,opt}. (12)

For {Q_{R}}, due in part to the half-duplex constraint, packet arrival and packet departure will not occur in the same slot, as the increase of Q_{R} has lower priority than its decrease. So the probability that Q_{R} decreases by one equals the probability of successful transmission on the R-D link. Thus, the state transition probabilities of {Q_{R}} are λ_{R}ⁿ=(1−q_{S}⁰)p_{SR}^{succ,opt}, λ_{R}^{1≦n≦L-1}=(1−q_{R}⁰)p_{SR}^{succ,opt}(1−p_{RD}^{succ,opt}), and μ_{R}^{1≦n≦L}=p_{RD}^{succ,opt}. So the steady state probability of Q_{R}=0 is

$${q}_{R}^{0} = {( 1 + \frac{{\sum }_{k = 1}^{L} {( \frac{( 1 - {q}_{S}^{0} ) {p}_{SR}^{succ , opt} ( 1 - {p}_{RD}^{succ , opt} )}{{p}_{RD}^{succ , opt}} )}^{k}}{1 - {p}_{RD}^{succ , opt}} )}^{- 1} \qquad ( 13 )$$

The steady state probability of Q_{R}=k can be further obtained via similar calculations used in Equation (9) as

$${q}_{R}^{k} = \frac{{q}_{R}^{0}}{1 - {p}_{RD}^{succ , opt}} {( ( 1 - {q}_{S}^{0} ) {p}_{SR}^{succ , opt} ( 1 - {p}_{RD}^{succ , opt} ) / {p}_{RD}^{succ , opt} )}^{k}$$

Since q_{R}^{L} is function of q_{R}⁰, solving the combined equations of (11) and (13), the solutions for q_{S}⁰ and q_{R}⁰ can thereby be obtained, which can further lead to the results of the stability region λ* and the average end-to-end delay. These general results derived above can now be applied to the SDF and BDF protocols, respectively.

With regard to the SDF protocol, L=1 and {Q_{R}} can be reduced to a two-state Markov chain with q_{R}^{L}=1−q_{R}⁰. Therefore, by solving Equations (11) and (13), the result can be

q_{S}⁰=1−λ/(p_{SR}^{succ,opt}−p_{SR}^{succ,opt}λ/p_{RD}^{succ,opt}), (14)

q_{R}⁰=1−λ/p_{RD}^{succ,opt}, (15)

respectively. The stability region can be obtained from the requirement q_{S}⁰>0 and the average end-to-end delay can be calculated according to Equation (7). Theorem 2 summarizes the results.

Theorem 2: The stability region and the average end-to-end delay for the SDF protocol are

$$\begin{matrix}{λ}_{SDF}^{*} = \frac{{p}_{RD}^{succ , opt} {p}_{SR}^{succ , opt}}{{p}_{RD}^{succ , opt} + {p}_{SR}^{succ , opt}} & ( 16 ) \\ {\overline{W}}_{SDF} = \frac{1 - λ}{{p}_{SR}^{succ , opt} - \frac{{p}_{SR}^{succ , opt}}{{p}_{RD}^{succ , opt}} λ - λ} + \frac{1}{{p}_{RD}^{succ , opt}} . & ( 17 )\end{matrix}$$

With regard to the BDF protocol, L=∞ and then for a stable system q_{R}^{L}=0. Correspondingly, there can be

$${q}_{S}^{0} = 1 - λ / [ ( 1 - λ ) {p}_{SR}^{succ , opt} ] , {q}_{R}^{0} = 1 - λ / {p}_{RD}^{succ , opt} \qquad ( 18 )$$

respectively. The stability region can be obtained from satisfying the requirements of both q_{S}⁰>0 and q_{R}⁰>0, and the average end-to-end delay can be calculated according to Equation (7). Theorem 3 summarizes the above results.

Theorem 3 The stability region and the average end-to-end delay for the BDF protocol are

$$\begin{matrix}{λ}_{BDF}^{*} = min \{ \frac{{p}_{SR}^{succ , opt}}{1 + {p}_{SR}^{succ , opt}} , {p}_{RD}^{succ , opt} \} , & ( 19 ) \\ {\overline{W}}_{BDF} = \frac{1 - λ}{( 1 - λ ) {p}_{SR}^{succ , opt} - λ} + \frac{1 - λ}{{p}_{RD}^{succ , opt} - λ} . & ( 20 )\end{matrix}$$

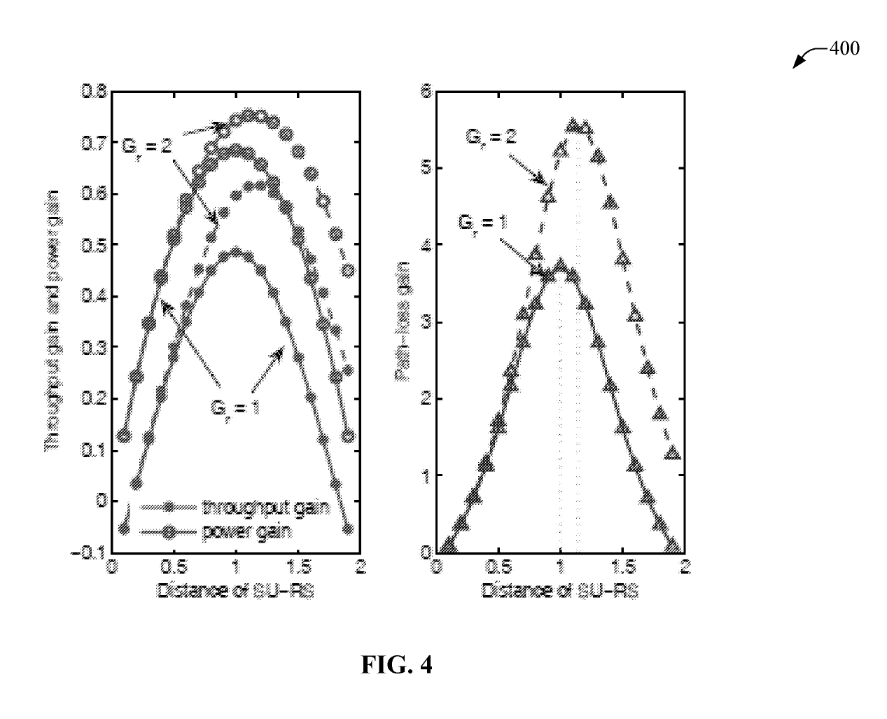

Path-loss gain and buffer gain relating to aspects of the disclosed subject matter can be analyzed. Path-loss gain is referred to as the gain that a CRS obtains from the reduction in path-loss over the BL system. The metric throughput per Watt can be used to illustrate this gain, which is defined as the average throughput (in bits/slot) of delivering a single packet from the SU-Tx to the SU-Rx divided by the transmit power needed, denoted by ΔT_{P}. Referring to FIG. 4, illustrated is an example graph 400 of path-loss gain of CRS over a baseline (BL) system as a function of the location of the SU-RS, for different distances of the SU-RS in accordance with various aspects. Here it can be assumed the SU-Tx and the SU-Rx are fixed at (0, 0) and (2, 0) kilometers (km), respectively, while the SU-RS is located at (D_{SR}, 0). In FIG. 4, D_{SD}=2 km, ρ=2 per km², π₀=0.8. It can be shown that setting P_{SR}^{opt}(D_{SR})=P_{RD}^{opt}(D_{SD}−D_{SR}) can achieve the peak of the path-loss gain, which implies

$${D}_{SR}^{*} = ( 1 - {C}_{4} ) {D}_{SD} , {D}_{RD}^{*} = {C}_{4} {D}_{SD} , \\ where {C}_{4} = \frac{{G}_{r}^{- 1 / α}}{1 + {G}_{r}^{- 1 / α}} .$$

The buffer gain is referred to as the gain that comes from enabling the buffering capability at the SU-RS. It can be shown that the relative increase in the stability region and the reduction in the average end-to-end delay under the BDF protocol (infinite buffer) compared with the SDF protocol (single packet storage) can be denoted by Δλ*=λ_{BDF}*/λ_{SDF}*−1 and Δ W̅=1− W̅_{BDF}/ W̅_{SDF}, respectively

Property 2: Given the SU-RS located at (D_{SR}*, 0), and let

$$ζ {=}^{Δ} {p}_{RD}^{succ , opt} {\vert}_{{D}_{RD} = {D}_{RD}^{+}} = {( {p}_{SD}^{succ , opt} )}^{{C}_{4} \frac{2 {α}^{′}}{α + 2} } ,$$

the buffer gain in stability region and in average end-to-end delay are

$$Δ {λ}^{*} = \frac{1 - ζ}{1 + ζ} > 0 , Δ \overline{W} = \frac{\frac{{λ}^{2}}{1 - λ} ( 1 - ζ )}{( ζ - λ ) ( ζ - \frac{λ}{1 - λ} )} > 0. \qquad ( 21 )$$

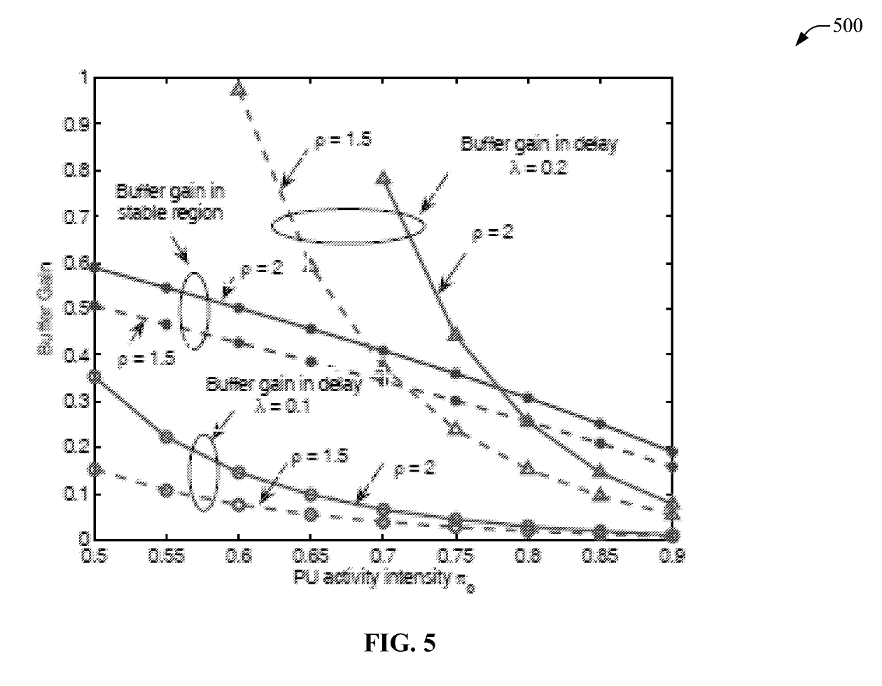

The value of ζ in Equation (21) can depend at least in part on the system parameters, such as α and Gᵣ, as well as PU distribution density ρ and PU activity intensity π₀. Referring briefly to FIG. 5, depicted is an example graph 500 of buffer gain in both stability region and average end-to-end delay of CRS under the BDF protocol over that under the SDF protocol with different PU activity intensity π₀ in accordance with various aspects. In graph 500, ρ=2 per km², D_{SD}=2 km, and the SU-RS is fixed at (D_{SR}*, 0)=((1−C₄)D_{SD}, 0)=(1.086, 0) km. The graph 500 shows how the buffer gain varies with PU activity intensity π₀ and PU distribution density. From FIG. 5, it can be seen that the buffer gain increases when the cognitive environment is more unfavorable (e.g. larger intensity of PU activity and higher density of PU distribution).

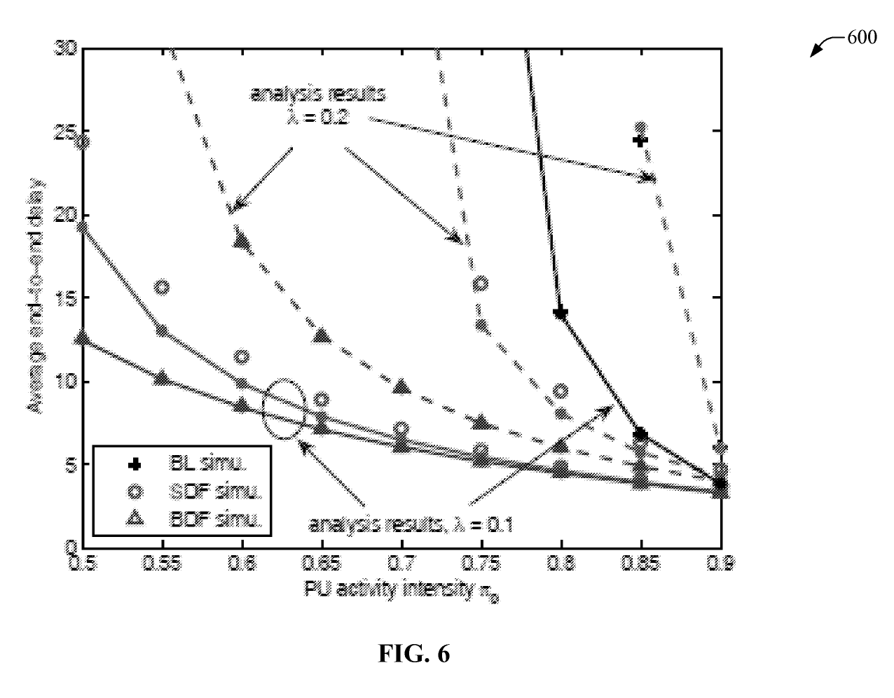

End-to-end delay performance under the three protocols and verify our analytical results via Monte Carlo simulations. The packet size M=16 kbits and the channel bandwidth is B=16 kHz. Other parameters are set as follows: κ₀=1, α=4, σ²=σ₁²=1, Gₜ=Gᵣ=2, θ=π/3 rad, and γth=1. Referring briefly to FIG. 6, depicted is an example graph 600 of average end-to-end delay under the BDF, SDF, and BL protocols with different PU activity intensity π₀ in accordance with various aspects. In graph 600, D_{SD}=2 km and SU-RS is fixed at (D_{SR}*, 0)=((1−C₄)D_{SD}, 0)=(1.086, 0) km, ρ=2 per km². The graph 600 shows the trend that the average end-to-end delay varies with decreasing PU activity intensity. It can be seen that the simulation results match well with the corresponding analytical results. Moreover, the BDF protocol always can achieve larger stability region and smaller delay than the SDF protocol, as claimed in Property 2.

As can be seen, the disclosed subject matter, by employing the CRS, in accordance with the various aspects and embodiments disclosed herein, can provide two levels of gains, e.g., path-loss gain and buffer gain, which is an improvement over conventional communication systems. The path-loss gain can substantially increase the spectrum access opportunities at least in part by reducing the transmit power while the buffering capability at the relay (e.g., SRS or SU-RS) can further save the blockage time of either the S-R link or R-D link and can reduce the end-to-end delay to a larger extent, as compared to conventional communication systems. It can therefore be desirable to exploit relay buffers to better manage any uncertainty relating to PU activities, which is an intrinsic issue associated with large-coverage cognitive systems. The disclosed subject matter, by employing relay buffers at the relay and the BDF protocol, can better manage any uncertainty relating to PU activities while using the relay to forward packets of information received from a SSD to a SDD, as compared to conventional communication systems.

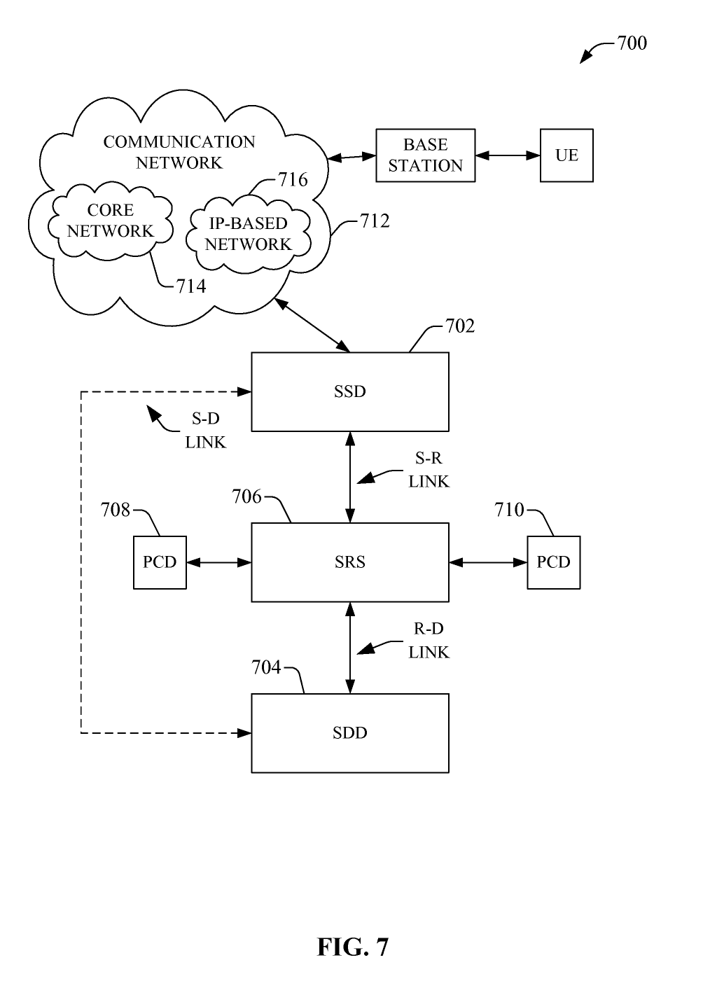

FIG. 7 illustrates a block diagram of another example system 700 that can facilitate communications using cognitive relay in accordance with various aspects and embodiments of the disclosed subject matter. In accordance with various aspects, the system 700 can be utilized to facilitate enabling SUs (e.g., base station, mobile communication device) associated with a secondary communication system to utilize available portions of the spectrum associated with a primary communication system to communicate at least a portion of voice or data transmissions between the SUs communicating wirelessly in a wireless communication environment. In accordance with various aspects, the system 700 can include a SSD 702 (e.g., base station), SDD 704 (e.g., mobile communication device), and SRS 706 (e.g., relay station), and a plurality of primary communication devices, including primary communication devices 708 and 710, wherein each of the SSD 702, SDD 704, SRS 706, and primary communication devices 708 and 710, respectively, can be the same as or similar to, or can comprise the same or similar functionality as, respective components (e.g., respectively named components), as disclosed herein.

In an aspect, the system 700 can comprise a communication network 712 that can be utilized to facilitate wireless communication of voice and data information between communication devices associated with (e.g., communicatively connected via a wireless or wireline communication connection or channel) the communication network 712. The communication network 712 can comprise a core network 714 (e.g., Second Generation (2G), Third Generation (3G), Fourth Generation (4G), or x-Generation (xG) network, where x is virtually any desired integer or real value) that can be used to facilitate wireless communication of information between communication devices (e.g., wireless communication devices, such as SDD 704 and UE 720) associated with the communication network 712. In another aspect, the communication network 712 can include an IP-based network 716, which can be associated with the core network 714, to facilitate IP-based communications between communication devices associated with the communication network 712.

The core network 714 and IP-based network 716, respectively, can allocate resources to communication devices in the respective networks, convert or enforce protocols, establish and enforce Quality of Service (QoS) for the communication devices respectively associated therewith, provide applications or services in the respective networks, translate signals, and/or perform other desired functions to facilitate system interoperability and communication in the respective wireless communication networks. The core network 714 and IP-based network 716, respectively, can include desired components, such as routers, nodes, switches, interfaces, controllers, gateways, etc., that can facilitate communication of voice or data between communication devices in the communication network 712.

In an aspect, the system 700 can include a base station 718, which can be connected to the communication network 712 to facilitate communications by the UE 720 connected (e.g., wirelessly connected) to the base station 718, wherein the base station 718 and UE 720 respectively can function as more fully disclosed herein. When desired, the SDD 704 can communicate with other communication devices, such as UE 720. The communication of voice or data between the SDD 704 and UE 720 can be facilitated, at least in part, by relaying at least a portion of the voice or data communications via the SRS 706, as more fully disclosed herein.

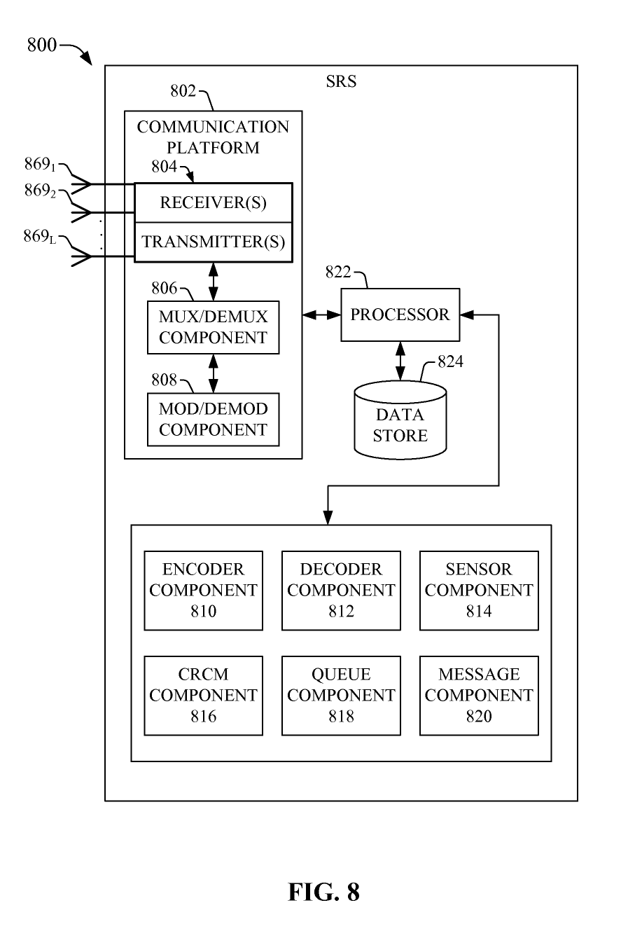

FIG. 8 illustrates a block diagram of an example SRS 800 in accordance with various aspects and embodiments of the disclosed subject matter. In an aspect, the SRS 800 can receive and transmit signal(s) from and to wireless devices like access points (e.g., base stations, femto APs, pico APs), access terminals (e.g., UEs), wireless ports and routers, and the like, through a set of antennas 869₁-869_{L}, wherein L can be virtually any desired positive integer number. In an aspect, the antennas 869₁-869_{L} are a part of a communication platform 802, which comprises electronic components and associated circuitry that can provide for processing and manipulation of received signal(s) and signal(s) to be transmitted. In an aspect, the communication platform 802 can include a receiver/transmitter 804 that can convert signal from analog to digital upon reception, and from digital to analog upon transmission. In addition, receiver/transmitter 804 can divide a single data stream into multiple, parallel data streams, or perform the reciprocal operation.

In an aspect, coupled to receiver/transmitter 804 can be a multiplexer/demultiplexer (mux/demux) 806 that can facilitate manipulation of signal in time and frequency space. The mux/demux 806 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 806 can scramble and spread information (e.g., codes) according to substantially any code known in the art, e.g., Hadamard-Walsh codes, Baker codes, Kasami codes, polyphase codes, and so on. A modulator/demodulator (mod/demod) 808 also can be part of the communication platform 802, and can modulate information according to multiple modulation techniques, such as frequency modulation, amplitude modulation (e.g., M-ary quadrature amplitude modulation (QAM), with Ma positive integer), phase-shift keying (PSK), and the like.

In an aspect, the SRS 800 can contain an encoder component 810 that can encode, convert, or modify voice or data communications (e.g., bitstream or data stream) from one format or code to another format or code to facilitate efficient communication of voice and data, in accordance with one or more predefined communication protocols (e.g., encoding algorithms or protocols), in the communication network environment. As desired, the encoder component 810 also can compress voice or data communications, in accordance with one or more other communication protocols (e.g., compression algorithms or protocols). For instance, the encoder component 810 can encode one or more data packets to prepare the data packets for transmission from an SSD to an SDD, or vice versa, as part of a CRS, and/or for transmission between one primary communication device and another primary communication device.

In another aspect, the SRS 800 can contain an decoder component 812 that can decode, convert, or modify encoded voice or data communications (e.g., bitstream or data stream) from one format or code to another format or code (e.g., a decoded format or code) to facilitate efficient communication of voice and data, in accordance with one or more predefined communication protocols (e.g., decoding algorithms or protocols), in the communication network environment. As desired, the decoder component 812 also can decompress compressed voice or data communications, in accordance with one or more other communication protocols (e.g., decompression algorithms or protocols). For example, the decoder component 812 can decode one or more encoded data packets received from an SSD to facilitate relaying the data packets to an SDD, or vice versa, as part of a CRS, and/or decode one or more encoded data packets received from a primary communication device as part of transmission of the data packets between the primary communication device and another primary communication device.

In still another aspect, the SRS 800 can comprise a sensor component 814 that can monitor communication conditions in the communication network environment, and can detect, sense, or otherwise obtain information relating to communication conditions in the communication network environment. The information can be received from one or more sensors that are part of the sensor component 814 or other sensors (e.g., cognitive sensors) distributed throughout the coverage area associated with the SRS 800. The information can comprise information indicating a current activity state of a primary communication device, information indicating SNR or SINR of communication channel or link associated with the SRS 800, information indicating a link status (e.g., activity status) for an S-R link or R-D link, etc.

In yet another aspect, the SRS 800 can include a CRCM component 816 that can control communications, including controlling the relaying packets of information being transmitted from a SSD to an SDD, or vice versa, in accordance with one or more specified relay protocols (e.g., BDF, SDF, BL), in accordance with the predefined relay criteria. The CRCM component 816 can identify whether a communication link, such as the S-R link or R-D link is blocked at a given time and identify whether a PU associated with the SRS 800 is active (e.g., is in an active state and/or is actively communicating) at a given time to facilitate determining whether a packet is to be communicated to or from the SRS 800 as part of the CRS relay. In another aspect, the CRCM component 816 can control a queue component 818 of the SRS 800 to insert or remove packets from the queue component 818, in accordance with the one or more specified relay protocols being employed in the CRS. In one embodiment, the queue component 818 can be a FIFO queue, although other types of queues can be employed, as desired.

In an aspect, the CRCM component 816, upon receiving a packet (e.g., from an SSD) for relay to a destination (e.g., SDD), can employ the decoder component 812 to decode the packet, and can re-encode the decoded packet using the encoder component 810, wherein the packet can be placed in the next available slot (e.g., first available slot proceeding from the front of the FIFO queue to the back of the FIFO queue) in the queue component 818. When the CRCM component 816 determines that a packet is to be forwarded to the destination, the CRCM component 816 can generate a copy of the next packet (e.g., packet in the first slot of the FIFO queue) from the queue component 818, and the SRS 800 can transmit the copy of the next packet to the destination.

In another aspect, the SRS 800 can comprise a message component 820 that can generate or receive various types of messages or signals to facilitate controlling data flow (e.g., communication of packets) associated with the SRS 800. For instance, the message component 820 can receive a message, such as an acknowledgement message, from an SDD (or SSD), wherein the acknowledgement message can indicate that a communication, such as a packet, has been received by the SDD (or SSD). For example, when an acknowledgement message, which indicates that the SDD has received a packet transmitted by the SRS 800 to the SDD, is received by the message component 820, the CRCM component 816 can remove the corresponding packet (e.g., the packet in the queue for which a copy was made to transmit to the SDD) from the queue component 818, and the remaining packets (if any) in the queue can move up a slot in the queue component 818.

The SRS 800 also can comprise a processor(s) 822 that can be configured to confer and/or facilitate providing functionality, at least partially, to substantially any electronic component in or associated with the SRS 800. For instance, the processor(s) 822 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, etc. The processor(s) 822 also can facilitate other operations on data for measurement of radio link quality or reception of information related thereto, controlling packet relay operations, controlling queue operation, identifying whether a link (e.g., S-R link, R-D link) is blocked at a given time, identifying whether a PU is in an active state at a given time, identifying whether a destination (e.g., SDD) has received a packet, encoding or decoding data, etc.

In another aspect, the SRS 800 can include a data store 824 that can store data structures; code instructions; rate coding information; information relating to measurement of radio link quality or reception of information related thereto; controlling packet relay operations; controlling queue operation; identifying whether a link (e.g., S-R link, R-D link) is blocked at a given time; identifying whether a PU is in an active state at a given time; identifying whether a destination (e.g., SDD) has received a packet; encoding or decoding data; system or device information like policies and specifications; code sequences for scrambling; spreading and pilot transmission; floor plan configuration; access point deployment and frequency plans; scheduling policies; and so on. The processor(s) 822 can be coupled to the data store 824 in order to store and retrieve information (e.g., information, such as algorithms, relating to multiplexing/demultiplexing or modulation/demodulation, radio link levels, controlling packet relay operations, controlling queue operation, identifying whether a link is blocked at a given time, identifying whether a PU is in an active state at a given time, identifying whether a destination has received a packet, encoding or decoding data, etc.) desired to operate and/or confer functionality to the communication platform 802, the encoder component 810, the decoder component 812, the sensor component 814, the CRCM component 816, the queue component 818, the message component 820, and/or other operational components of SRS 800.

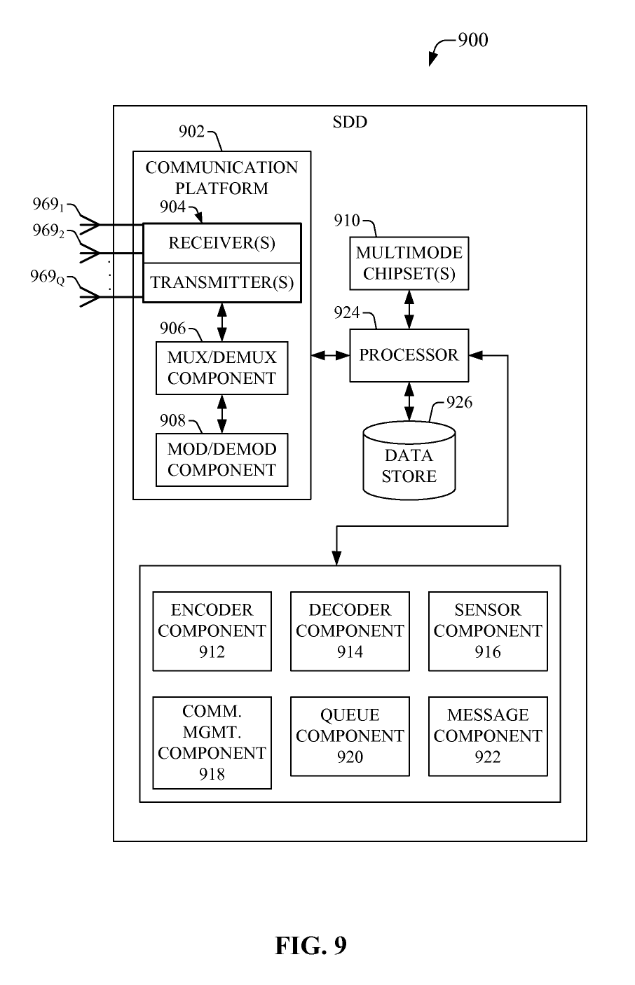

FIG. 9 depicts a block diagram of an example SDD 900 (e.g., mobile communication device) in accordance with various aspects and embodiments of the disclosed subject matter. In an aspect, the SDD 900 can be a multimode access terminal, wherein an antenna set comprising one or more antennas 969₁-969_{Q} (Q is a positive integer) can receive and transmit signal(s) from and to wireless devices like access points, access terminals, wireless ports and routers, and so forth, that operate in a radio access network. It should be appreciated that antennas 969₁-969_{Q} are a part of communication platform 902, which comprises electronic components and associated circuitry that provide for processing and manipulation of received signal(s) and signal(s) to be transmitted; e.g., receivers and transmitters 904, multiplexer/demultiplexer (mux/demux) component 906, and modulation/demodulation (mod/demod) component 908. In one embodiment, the SDD 900 can employ one omnidirectional antenna.

In accordance with an embodiment, the SDD 900 can include a multimode operation chipset(s) 910 that can allow the SDD 900 to operate in multiple communication modes in accordance with disparate technical specification for wireless technologies. In an aspect, multimode operation chipset(s) 910 can utilize communication platform 902 in accordance with a specific mode of operation (e.g., voice, data, GPS). In another aspect, multimode operation chipset(s) 910 can be scheduled to operate concurrently (e.g., when Q>1) in various modes or within a multitask paradigm.

In an aspect, the SDD 900 can contain an encoder component 912 that can encode, convert, or modify voice or data communications (e.g., bitstream or data stream) from one format or code to another format or code to facilitate efficient communication of voice and data, in accordance with one or more predefined communication protocols (e.g., encoding algorithms or protocols), in the communication network environment. As desired, the encoder component 912 also can compress voice or data communications, in accordance with one or more other communication protocols (e.g., compression algorithms or protocols). For instance, the encoder component 912 can encode one or more data packets to prepare the data packets for transmission from the SDD 900 to an SSD or to an SRS.

In another aspect, the SDD 900 can contain an decoder component 914 that can decode, convert, or modify encoded voice or data communications (e.g., bitstream or data stream) from one format or code to another format or code (e.g., a decoded format or code) to facilitate processing the voice or data communications for presentation to a user, in accordance with one or more predefined communication protocols (e.g., decoding algorithms or protocols). For example, the decoder component 914 can decode one or more encoded data packets received from an SSD or SRS, as part of the CRS. As desired, the decoder component 914 also can decompress compressed voice or data communications, in accordance with one or more other communication protocols (e.g., decompression algorithms or protocols).

In still another aspect, the SDD 900 can comprise a sensor component 916 that can monitor communication conditions in the communication network environment, and can detect, sense, or otherwise obtain information relating to communication conditions in the communication network environment. The information can be received from one or more sensors that are part of the sensor component 916 or other sensors (e.g., cognitive sensors) distributed throughout the coverage area associated with the SDD 900. The information can comprise information indicating a current activity state of a primary communication device, information indicating SNR or SINR of communication channel or link associated with the SDD 900, information indicating a link status (e.g., activity or blocked status) for an S-R link, R-D link or S-D link, etc.

In yet another aspect, the SDD 900 can include a communication management component 918 (also referred to as comm. mgmt. component 918) that can control communications, including controlling the receiving of packets from an SRS relaying packets sent by an SSD to the SDD 900 and/or transmitting packets directly to the SSD or to the SRS for relay to the SSD, in accordance with one or more specified relay protocols (e.g., BDF, SDF, BL), in accordance with the predefined relay criteria. In one aspect, when the SDD 900 is communicating information to the SSD, the communication management component 918 can identify whether a communication link (e.g., R-D link, S-R link, S-D link) is blocked at a given time and identify whether a PU associated with the SRS is active (e.g., is in an active state and/or is actively communicating) at a given time to facilitate determining whether a packet is to be communicated to the SRS as part of the CRS relay or whether the packet is to be transmitted directly to the SSD. In another aspect, the communication management component 918 can control a queue component 920 of the SDD 900 to insert or remove packets from the queue component 920, in accordance with the one or more specified relay protocols. In one embodiment, the queue component 920 can be a FIFO queue, although other types of queues can be employed, as desired.

In an aspect, the communication management component 918, to facilitate communication of one or more packets to the SSD, can employ the encoder component 912, wherein the packets can be placed in the slots in the queue component 920 in an ordered manner, such as a FIFO order. When the communication management component 918 determines that a packet is to be transmitted, the communication management component 918 can generate a copy of the packet (e.g., packet in the first slot of the FIFO queue) from the queue component 920, and the SDD 900 can transmit the copy of the packet to the destination (e.g., SSD) or to the relay station (e.g., SRS).

In another aspect, the SDD 900 can comprise a message component 922 that can generate or receive various types of messages or signals to facilitate controlling data flow (e.g., communication of packets) associated with the SDD 900. For instance, when the SDD 900 receives a packet from the SSD, either directly or via relay by the SRS, the message component 922 can generate an acknowledgement message containing information indicating the packet has been received by the SDD 900, and the acknowledgement message can be transmitted from the SDD 900 to the SSD and/or SRS, to facilitate enabling the SSD and/or SRS to update their respective queue components.

As another example, in response to the SDD 900 transmitting a packet, the message component 922 can receive a message, such as an acknowledgement message, from an SRS or SSD, wherein the acknowledgement message can indicate that a communication, such as a packet, has been received by the SRS or SSD. For example, when an acknowledgement message, which indicates that the SSD has received a packet transmitted by the SDD 900 directly to the SSD or relayed by the SRS to the SSD, is received by the message component 922, the communication management component 918 can remove the corresponding packet (e.g., the packet in the queue for which a copy was made to transmit to the SSD) from the queue component 920, and the remaining packets (if any) in the queue can move up a slot in the queue component 920.

In still another aspect, the SDD 900 can include a processor(s) 924 that can be configured to confer functionality, at least in part, to substantially any electronic component within the SDD 900, in accordance with aspects of the disclosed subject matter. For example, the processor(s) 924 can facilitate enabling the SDD 900 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. As another example, the processor(s) 924 can facilitate enabling the SDD 900 to process data relating to measuring respective radio link qualities between the SDD 900 and other devices such as an SSD or SRS, identifying whether a link (e.g., R-D link, S-D link, S-R link) is blocked at a given time, controlling queue operation, identifying whether a PU is in an active state at a given time, identifying whether a destination (e.g., destination, such as an SSD, with respect to the SDD 900) has received a packet, encoding or decoding data, etc.

The SDD 900 also can contain a data store 926 that can store data structures (e.g., user data, metadata); code structure(s) (e.g., modules, objects, classes, procedures) or instructions; information relating to measuring respective radio link qualities between the SDD 900 and an SSD or SRS; identifying whether a link (e.g., R-D link, S-D link) is blocked at a given time; controlling queue operation; identifying whether a PU is in an active state at a given time; identifying whether a destination (e.g., destination, such as an SSD, with respect to the SDD 900) has received a packet; encoding or decoding data; network or device information like policies and specifications; attachment protocols; code sequences for scrambling, spreading and pilot (e.g., reference signal(s)) transmission; frequency offsets; cell IDs; encoding algorithms; compression algorithms; decoding algorithms; decompression algorithms; and so on. In an aspect, the processor(s) 924 can be functionally coupled (e.g., through a memory bus) to the data store 926 in order to store and retrieve information (e.g., information relating to measuring radio link levels, link status, activity status of PUs, status of a packet, queue control, frequency offsets, desired algorithms, etc.) desired to operate and/or confer functionality, at least in part, to communication platform 902, multimode operation chipset(s) 910, encoder component 912, decoder component 914, sensor component 916, communication management component 918, queue component 920, message component 922, and/or substantially any other operational aspects of the SDD 900.

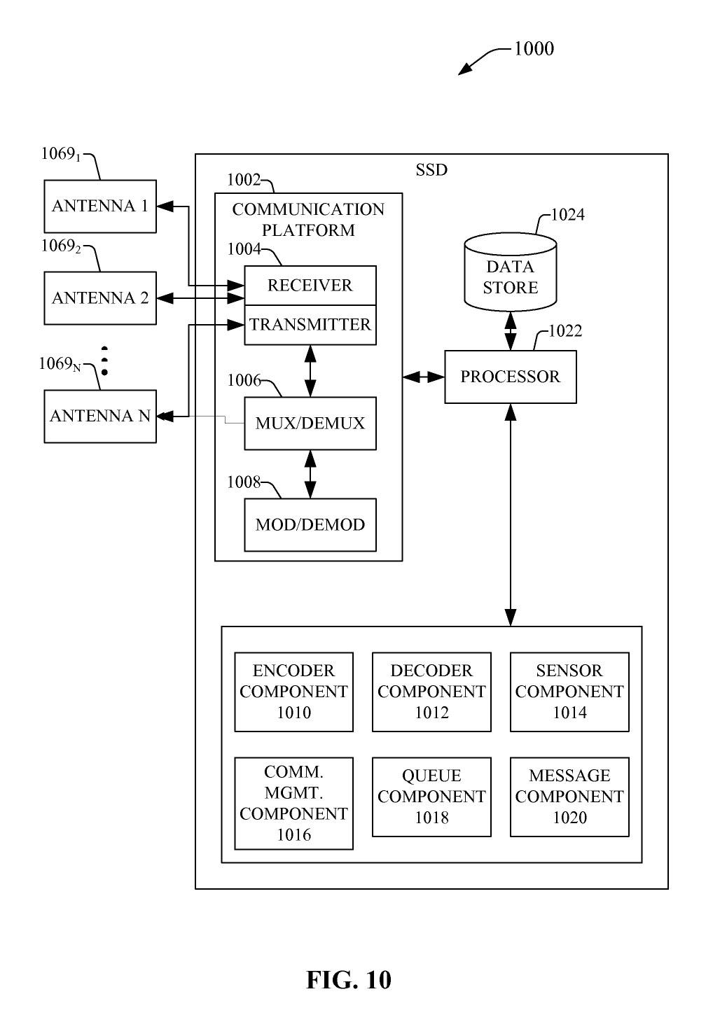

FIG. 10 illustrates a block diagram of an example SSD 1000 (e.g., base station) in accordance with an aspect of the disclosed subject matter. The SSD 1000 can receive and transmit signal(s) from and to wireless devices like access points (e.g., SRS, base stations, femto APs, pico APs), access terminals (e.g., SDDs or UEs), wireless ports and routers, and the like, through a set of antennas 1069₁-1069_{N}, wherein N can be virtually any desired positive integer number. In an aspect, the antennas 1069₁-1069_{N} can be part of a communication platform 1002, which comprises electronic components and associated circuitry that can provide for processing and manipulation of received signal(s) and signal(s) to be transmitted. In an aspect, the communication platform 1002 can include a receiver/transmitter 1004 that can convert signal from analog to digital upon reception, and from digital to analog upon transmission. In addition, receiver/transmitter 1004 can divide a single data stream into multiple, parallel data streams, or perform the reciprocal operation.

In an aspect, coupled to receiver/transmitter 1004 can be a multiplexer/demultiplexer (mux/demux) 1006 that can facilitate manipulation of signal in time and frequency space. The mux/demux 1006 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 1006 can scramble and spread information (e.g., codes) according to substantially any code known in the art, e.g., Hadamard-Walsh codes, Baker codes, Kasami codes, polyphase codes, and so on. A modulator/demodulator (mod/demod) 1008 also can be part of the communication platform 1002, and can modulate information according to multiple modulation techniques, such as frequency modulation, amplitude modulation (e.g., M-ary quadrature amplitude modulation (QAM), with Ma positive integer), phase-shift keying (PSK), and the like.

In an aspect, the SSD 1000 can contain an encoder component 1010 that can encode, convert, or modify voice or data communications (e.g., bitstream or data stream) from one format or code to another format or code to facilitate efficient communication of voice and data, in accordance with one or more predefined communication protocols (e.g., encoding algorithms or protocols), in the communication network environment. As desired, the encoder component 1010 also can compress voice or data communications, in accordance with one or more other communication protocols (e.g., compression algorithms or protocols). For instance, the encoder component 1010 can encode one or more data packets to prepare the data packets for transmission from the SSD 1000 to directly to an SDD, or to an SRS for relay to the SDD.

In another aspect, the SSD 1000 can contain an decoder component 1012 that can decode, convert, or modify encoded voice or data communications (e.g., bitstream or data stream) from one format or code to another format or code (e.g., a decoded format or code) to facilitate obtaining the underlying or unencoded data in an encoded voice or data communication, wherein the data can be further processed for transmission to a desired destination (e.g., a UE), in accordance with one or more predefined communication protocols (e.g., decoding algorithms or protocols). For example, the decoder component 1012 can decode one or more encoded data packets received from an SDD or an SRS as part of the CRS. As desired, the decoder component 1012 also can decompress compressed voice or data communications, in accordance with one or more other communication protocols (e.g., decompression algorithms or protocols).

In still another aspect, the SSD 1000 can comprise a sensor component 1014 that can monitor communication conditions in the communication network environment, and can detect, sense, or otherwise obtain information relating to communication conditions in the communication network environment. The information can be received from one or more sensors that are part of the sensor component 1014 or other sensors (e.g., cognitive sensors) distributed throughout the coverage area associated with the SSD 1000. The information can comprise information indicating a current activity state of a primary communication device, information indicating SNR or SINR of communication channel or link associated with the SSD 1000, information indicating a link status (e.g., activity or blocked status) for an S-R link, R-D link or S-D link, etc.

In yet another aspect, the SSD 1000 can include a communication management component 1016 (also referred to as comm. mgmt. component 1016) that can control communications, including controlling the transmitting of packets directly to the SDD or to the SRS for relay to the SDD, and/or the receiving of packets from an SRS relaying packets sent by an SDD to the SSD 1000, in accordance with one or more specified relay protocols (e.g., BDF, SDF, BL) and other applicable predefined relay criteria. In one aspect, when the SSD 1000 is communicating information to the SDD, the communication management component 1016 can identify whether a communication link (e.g., R-D link, S-R link, S-D link) is blocked at a given time and/or identify whether a PU associated with the SRS is active (e.g., is in an active state and/or is actively communicating) at a given time to facilitate determining whether a packet is to be communicated to the SRS as part of the CRS relay or whether the packet is to be transmitted directly to the SDD. In another aspect, the communication management component 1016 can control a queue component 1018 of the SSD 1000 to insert or remove packets from the queue component 1018, in accordance with the one or more specified relay protocols. In one embodiment, the queue component 1018 can be a FIFO queue, although other types of queues can be employed, as desired.

In an aspect, the communication management component 1016, to facilitate communication of one or more packets to the SDD, can employ the encoder component 1010, wherein the packets can be placed in the slots in the queue component 1018 in an ordered manner, such as a FIFO order. When the communication management component 1016 determines that a packet is to be transmitted, the communication management component 1016 can generate a copy of the packet (e.g., packet in the first slot of the FIFO queue) from the queue component 1018, and the SSD 1000 can transmit the copy of the packet to the destination (e.g., SDD) or to the relay station (e.g., SRS).

In another aspect, the SSD 1000 can comprise a message component 1020 that can generate or receive various types of messages or signals to facilitate controlling data flow (e.g., communication of packets) associated with the SDD 900. For instance, in response to the SSD 1000 transmitting a packet, the message component 1020 can receive a message, such as an acknowledgement message, from an SRS or SDD, wherein the acknowledgement message can indicate that a communication, such as a packet, has been received by the SRS or SDD. For example, when an acknowledgement message, which indicates that the SDD has received a packet transmitted by the SSD 1000 directly to the SDD or relayed by the SRS to the SDD, is received by the message component 1020, the communication management component 1016 can remove the corresponding packet (e.g., the packet in the queue for which a copy was made to transmit to the SDD) from the queue component 1018, and the remaining packets (if any) in the queue can move up a slot in the queue component 1018.

In another instance, when the SSD 1000 receives a packet from the SDD, either directly or via relay by the SRS, the message component 1020 can generate an acknowledgement message containing information indicating the packet has been received by the SSD 1000, and the acknowledgement message can be transmitted from the SSD 1000 to the SDD and/or SRS, to facilitate enabling the SDD and/or SRS to update their respective queue components, as disclosed herein.

The SSD 1000 also can comprise a processor(s) 1022 that can be configured to confer and/or facilitate providing functionality, at least partially, to substantially any electronic component in or associated with the SSD 1000. For instance, the processor(s) 1022 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, etc. The processor(s) 1022 also can facilitate other operations on data for enabling the SSD 1000 to process data relating to measuring respective radio link qualities between the SSD 1000 and other devices such as an SDD or SRS, identifying whether a link (e.g., R-D link, S-D link, S-R link) is blocked at a given time, controlling queue operation, identifying whether a PU is in an active state at a given time, identifying whether a destination (e.g., destination, such as an SDD, with respect to the SSD 1000) has received a packet, encoding or decoding data, etc.

In another aspect, the SSD 1000 can include a data store 1024 that can store data structures; code instructions; rate coding information; information relating to measurement of radio link quality or reception of information related thereto; information relating to identifying whether a link (e.g., R-D link, S-D link, S-R link) is blocked at a given time; information relating to controlling queue operation; information relating to identifying whether a PU is in an active state at a given time; information relating to identifying whether a destination (e.g., destination, such as an SDD, with respect to the SSD 1000) has received a packet; information relating to encoding or decoding data; system or device information like policies and specifications; code sequences for scrambling; spreading and pilot transmission; floor plan configuration; access point deployment and frequency plans; scheduling policies; and so on. The processor(s) 1022 can be coupled to the data store 1024 in order to store and retrieve information (e.g., information, such as algorithms, relating to multiplexing/demultiplexing or modulation/demodulation, information relating to radio link levels or load levels, information relating to modification of mode or status of the SSD 1000 with respect to an SDD (e.g., UE), etc.) desired to operate and/or confer functionality to the communication platform 1002, the encoder component 1010, the decoder component 1012, the sensor component 1014, the communication management component 1016, the queue component 1018, the message component 1020, and/or other operational components of SSD 1000.

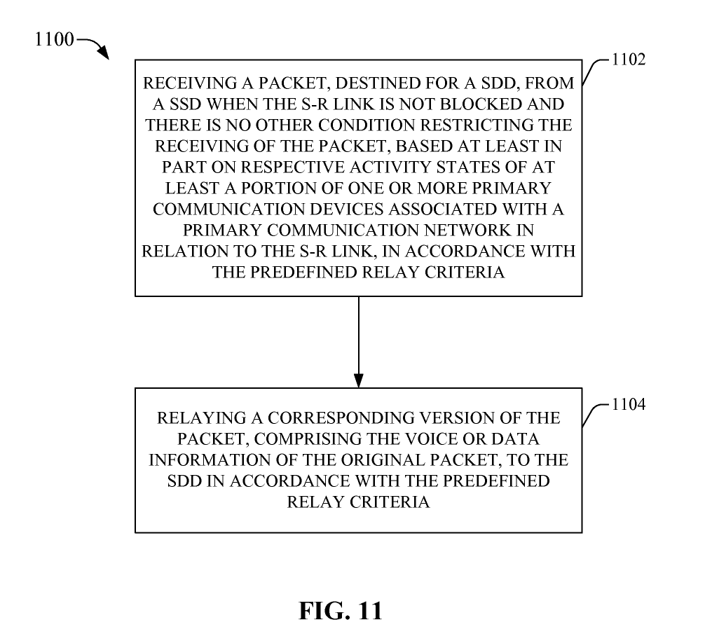

In view of the example systems described herein, example methods that can be implemented in accordance with the disclosed subject matter can be better appreciated with reference to flowcharts in FIGS. 11-17. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 11 presents a flowchart of an example method 1100 for controlling relaying of packets of information in a CRS, in accordance with various aspects and embodiments of the disclosed subject matter. The method 1100 can be employed, for example, by an SRS to relay at least a portion of one or more packets of data that are being transmitted, directly or indirectly (e.g., via relay in the CRS), by an SSD to an SDD of a secondary communication system, wherein the SRS also manages and facilitates communications by one or more PUs in the primary communication system.

At 1102, a packet destined for a SDD can be received from a SSD when the S-R link is not blocked and there is no other condition restricting the receiving of the packet (e.g., condition that restricts receiving the packet when the SRS is transmitting on the R-D link, when the applicable relay protocol is the BDF protocol), based at least in part on respective activity states of at least a portion of one or more primary communication devices associated with a primary communication network in relation to the S-R link, in accordance with the predefined relay criteria (e.g., including the applicable relay protocol). For instance, if the CRS is employing an SDF protocol at a given time, the SRS can receive the packet from the SSD when the S-R link is not blocked, wherein the SRS can identify whether the S-R link is blocked or not based at least in part on respective activity states of at least a portion of one or more primary communication devices associated with a primary communication network in relation to the S-R link, as more fully disclosed herein; and, if the CRS is employing an BDF protocol at a given time, the SRS can receive the packet from the SSD when the S-R link is not blocked and the SRS is not transmitting on the R-D link to the SDD. In another aspect, when the BL protocol is being employed, the SSD can transmit a packet directly to the SDD when the S-D link is not blocked.

At 1104, a corresponding version of the packet, comprising the voice or data information of the original packet, can be relayed to the SDD in accordance with the predefined relay criteria. In an aspect, the SRS can decode the packet originally received from the SSD, and can re-encode the voice or data information contained in the original packet to generate a corresponding version of the packet, comprising the voice or data information of the original packet, which can be inserted into the queue component of the SRS to await relay (e.g., transmission) to the SDD, as disclosed herein. The SRS also can generate and transmit an ACK message, which indicates the packet was successfully received by the SRS, to the SSD, wherein the SSD can take appropriate action in response to receiving the ACK from the SRS (e.g., remove the original packet from the SSD queue component; maintain knowledge of the receipt of the packet by the SRS and maintain the original packet in the SSD queue component or another storage location until an ACK is received from the SDD).

When the SDF protocol is employed, the packet can be relayed to the SDD in accordance with known forwarding techniques. When the BDF protocol is employed, the SRS relays the corresponding version of the packet to the SDD when the R-D link is not blocked. In accordance with various embodiments, the SRS and/or SSD can update their respective queues components to remove the corresponding version of the packet and/or original copy of the packet, respectively from their respective queue components, in response to receiving an acknowledgement message from the SDD indicating the copy of the corresponding version of the packet has been successfully received by the SDD.

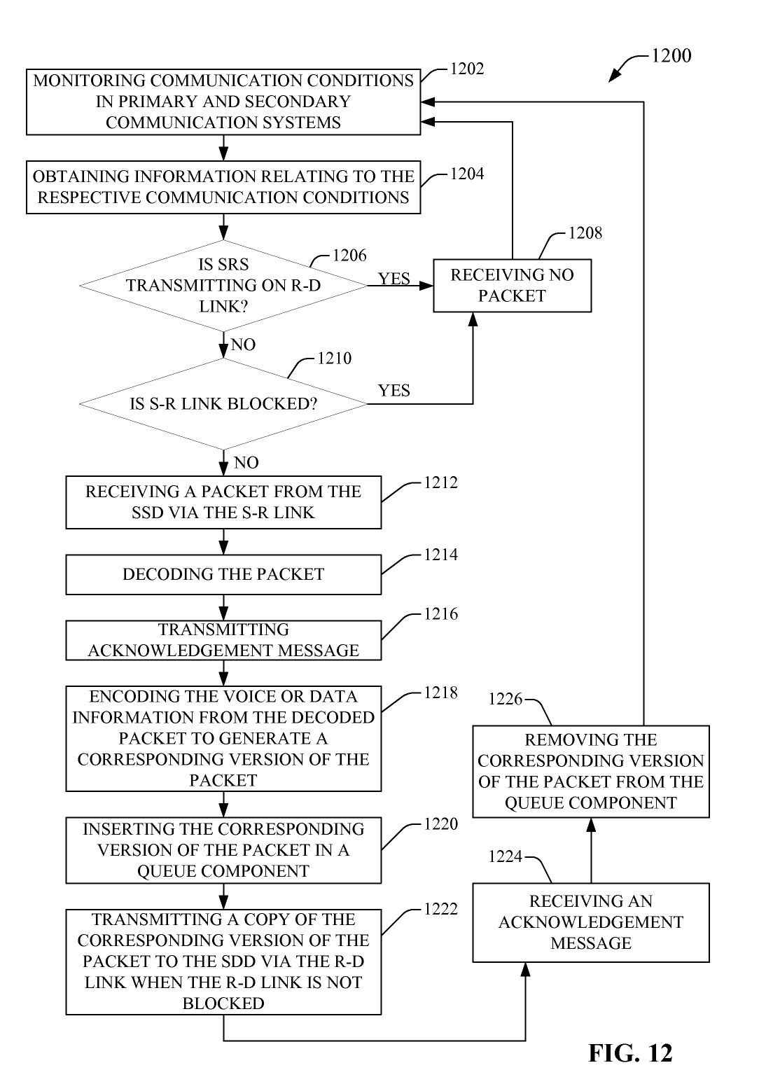

FIG. 12 depicts a flowchart of another example method 1200 that can employ a BDF protocol to facilitate controlling relaying of packets of information in a CRS, in accordance with various aspects and embodiments of the disclosed subject matter. The method 1200 can be employed, for example, by an SRS, employing a BDF protocol, to relay at least a portion of one or more packets of data that are being transmitted, directly or indirectly (e.g., via relay in the CRS), by an SSD to an SDD of a secondary communication system, wherein the SRS also manages and facilitates communications by one or more PUs in the primary communication system. At 1202, communication conditions associated with one or more primary communication devices (e.g., PUs) associated with the primary communication system and communication conditions associated with secondary devices associated with a secondary communication system can be monitored. In an aspect, the SRS can monitor respective communication conditions (e.g., activity state of a PU, link status of respective links, link quality of respective links, etc.) associated with PUs utilizing the primary communication system and secondary devices (e.g., SSD, SDD) associated with the secondary communication system.

At 1204, information relating to the respective communication conditions can be obtained. For instance, the SRS can sense, detect, receive, or otherwise obtain information relating to the respective communication conditions associated with one or more PUs utilizing the primary communication system and respective communication conditions associated with the secondary devices (e.g., SSD, SDD) associated with the secondary communication system.

At 1206, a determination can be made regarding whether the SRS is transmitting on the R-D link between the SRS and SDD, based at least in part on the information relating to the communication conditions. The SRS can identify whether the SRS is transmitting on the R-D link between the SRS and SDD, based at least in part on the information relating to the communication conditions. If it is determined that the SRS is transmitting on the R-D link, at 1208, no packet is received from the SSD by the SRS at this time. At this point, if no packet is received by the SRS from the SSD, method 1200 can return to reference numeral 1202, wherein the communication conditions can continue to be monitored. In an aspect, in instances where the SRS is not to receive a packet at a given time, in accordance with the BDF protocol, the SSD can directly transmit a packet to the SDD via the S-D link when the S-D link is not blocked, in accordance with the BL protocol, as more fully disclosed herein.

Referring again to reference numeral 1206, if, at 1206, it is determined that the SRS is not transmitting on the R-D link, at 1210, a determination can be made regarding whether the S-R link between the SSD and SRS is blocked at this time. The SRS can identify whether the S-R link is blocked, based at least in part on the information relating to the communication conditions. If it is determined that the S-R link is blocked at this time, method 1200 can proceed from reference numeral 1210 to reference numeral 1208, and, at 1208, no packet is received from the SSD by the SRS at this time. At this point, if no packet is received by the SRS from the SSD, method 1200 can return to reference numeral 1202, wherein the communication conditions can continue to be monitored.

Referring again to reference numeral 1210, if, at 1210, it is determined that the S-R link is not blocked at this time, at 1212, a packet can be received by the SRS from the SSD via the S-R link. At 1214, the packet can be decoded. For instance, the packet can be decoded, in accordance with a specified decoding algorithm or protocol, to retrieve the voice or data information in the packet. At 1216, an acknowledgement message can be transmitted to the SSD. For instance, the SRS can generate and transmit an acknowledgment message, which indicates the SRS has successfully received the packet, to the SSD, wherein the SSD can take an appropriate action (e.g., remove the original packet from the SSD queue component; maintain knowledge of the receipt of the packet by the SRS and maintain the original packet in the SSD queue component or another storage location until an ACK is received from the SDD).

At 1218, the voice or data information can be encoded to generate a corresponding version of the packet. For instance, the SRS can employ a specified encoding algorithm or protocol to encode the voice or data information of the received packet to generate a corresponding version of the packet, comprising the voice or data information, as encoded.

At 1220, the corresponding version of the packet can be inserted and stored in a queue component. For instance, the SRS can insert and store the version of the packet in a specified slot in the queue component of the SRS, wherein the version of the packet can be placed in the first slot in the queue component if there are no other packets awaiting relay to the SDD, or can be placed in order behind any other packets awaiting relay to the SDD (e.g., in FIFO order). At 1222, a copy of the corresponding version of the packet can be transmitted to the SDD via the R-D link when the R-D link is not blocked. In an aspect, the SRS can identify whether and when the R-D link is not blocked, based at least in part on information, which relates to the communication conditions of the R-D link, that is sensed, detected, received, or otherwise obtained by the SRS. When the corresponding version of the packet is the next packet for transmittal (e.g., in the first slot in the FIFO queue), and the R-D link is not blocked, the SRS can generate a copy of the corresponding version of the packet, and can relay (e.g., transmit) the version of the packet to the SDD via the R-D link, while maintaining the original of the corresponding version of the packet in the queue component.

At 1224, an acknowledgement message, which can comprise information indicating the SDD has received the copy of the version of the packet, can be received. For instance, in response to receiving the copy of the version of the packet, the SDD can generate and transmit an acknowledgement message to the SRS, which can receive such message. At 1226, the version of the packet can be removed from the queue component. In an aspect, the SRS can remove the version of the packet from the queue component and discard such packet, in response to receiving the acknowledgement message. If there are any other packets in the queue component, the packets each can move up a slot in the queue component, in accordance with the predefined relay criteria. At this point, method 1200 can proceed to reference numeral 1202, to continue to monitor the communication conditions, and to further proceed to determine whether and when to receive packets from an SSD and relay packets to the SDD.

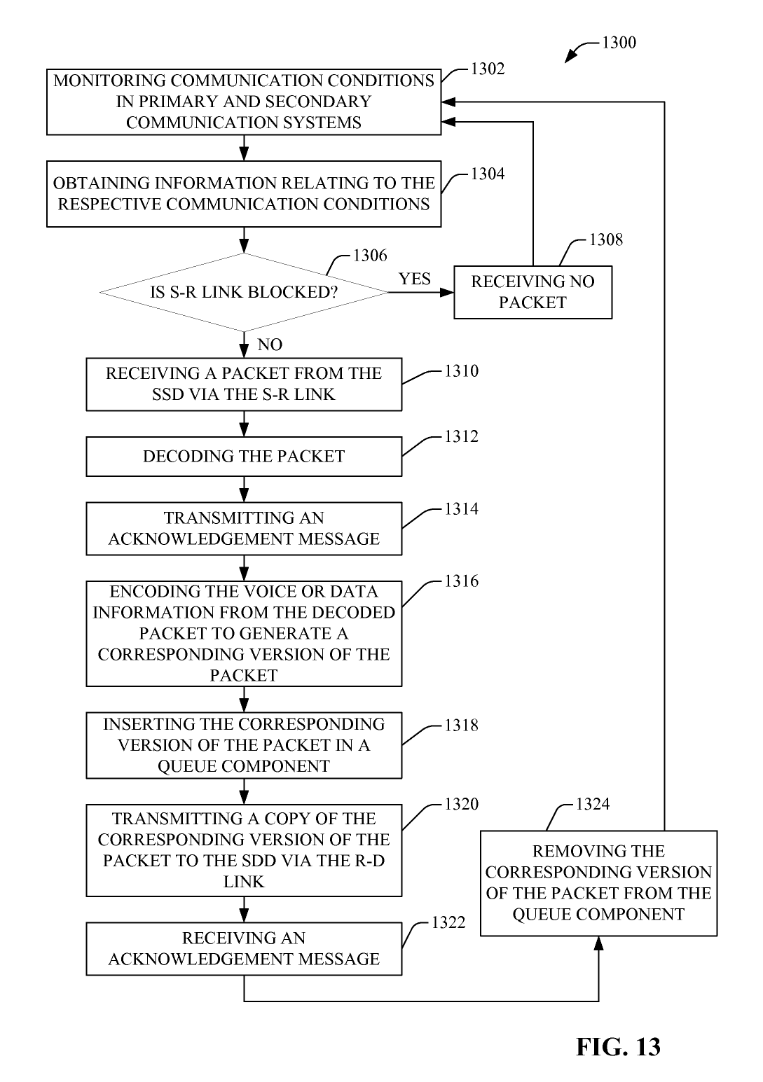

FIG. 13 illustrates a flowchart of an example method 1300 that can employ an SDF protocol to facilitate controlling relaying of packets of information in a CRS, in accordance with various aspects and embodiments of the disclosed subject matter. The method 1300 can be employed, for example, by an SRS, employing the SDF protocol, to relay at least a portion of one or more packets of data that are being transmitted, directly or indirectly (e.g., via relay in the CRS), by an SSD to an SDD of a secondary communication system, wherein the SRS also manages and facilitates communications by one or more PUs in the primary communication system.

At 1302, communication conditions associated with one or more primary communication devices (e.g., PUs) associated with the primary communication system and communication conditions associated with secondary devices associated with a secondary communication system can be monitored. In an aspect, the SRS can monitor respective communication conditions (e.g., activity state of a PU, link status of respective links, link quality of respective links, etc.) associated with PUs utilizing the primary communication system and secondary devices (e.g., SSD, SDD) associated with the secondary communication system.

At 1304, information relating to the respective communication conditions can be obtained. For instance, the SRS can sense, detect, receive, or otherwise obtain information relating to the respective communication conditions associated with one or more PUs utilizing the primary communication system and respective communication conditions associated with the secondary devices (e.g., SSD, SDD) associated with the secondary communication system.

At 1306, a determination can be made regarding whether the S-R link between the SSD and SRS is blocked at this time. The SRS can identify whether the S-R link is blocked, based at least in part on the information relating to the communication conditions. If it is determined that the S-R link is blocked at this time, at 1308, no packet is received from the SSD by the SRS at this time. At this point, if no packet is received by the SRS from the SSD, method 1300 can return to reference numeral 1302, wherein the communication conditions can continue to be monitored. In an aspect, in instances where the SRS is not to receive a packet from the SSD at a given time, in accordance with the SDF protocol, the SSD can directly transmit a packet to the SDD via the S-D link when the S-D link is not blocked, in accordance with the BL protocol, as more fully disclosed herein.

Referring again to reference numeral 1306, if, at 1306, it is determined that the S-R link is not blocked at this time, at 1310, a packet can be received by the SRS from the SSD via the S-R link. At 1312, the packet can be decoded. For instance, the packet can be decoded, in accordance with a specified decoding algorithm or protocol, to retrieve the voice or data information in the packet.

At 1314, an acknowledgement message can be transmitted to the SSD. For instance, the SRS can generate and transmit an acknowledgment message, which indicates the SRS has successfully received the packet, to the SSD, wherein the SSD can take an appropriate action (e.g., remove the original packet from the SSD queue component; maintain knowledge of the receipt of the packet by the SRS and maintain the original packet in the SSD queue component or another storage location until an ACK is received from the SDD).

At 1316, the voice or data information can be encoded to generate a corresponding version of the packet. For instance, the SRS can employ a specified encoding algorithm or protocol to encode the voice or data information of the received packet to generate a corresponding version of the packet, comprising the voice or data information, as encoded.

At 1318, the corresponding version of the packet can be inserted and stored in a queue component. For instance, the SRS can insert and store the corresponding version of the packet in a specified slot in the queue component of the SRS, wherein the corresponding version of the packet can be placed, for example in the first slot in the queue component. It is noted that, in accordance with the SDF protocol, the queue component will typically only have one packet at a given time, since the SRS typically will not receive a next packet from the SSD until a prior received packet is successfully forwarded to the SDD.

At 1320, a copy of the corresponding version of the packet can be transmitted to the SDD via the R-D link. In an aspect, the SRS can generate a copy of the corresponding version of the packet, and can relay (e.g., transmit, forward) the corresponding version of the packet to the SDD via the R-D link in accordance with known DF relay techniques, while maintaining the original of the corresponding version of the packet in the queue component. At 1322, an acknowledgement message, which can comprise information indicating the SDD has received the copy of the corresponding version of the packet, can be received. For instance, in response to receiving the copy of the corresponding version of the packet, the SDD can generate and transmit an acknowledgement message to the SRS, which can receive such message. At 1324, the corresponding version of the packet can be removed from the queue component. In an aspect, the SRS can remove the corresponding version of the packet from the queue component and discard such packet, in response to receiving the acknowledgement message. At this point, method 1300 can proceed to reference numeral 1302, to continue to monitor the communication conditions, and to further proceed to determine whether and when to receive packets from an SSD and relay packets to the SDD.

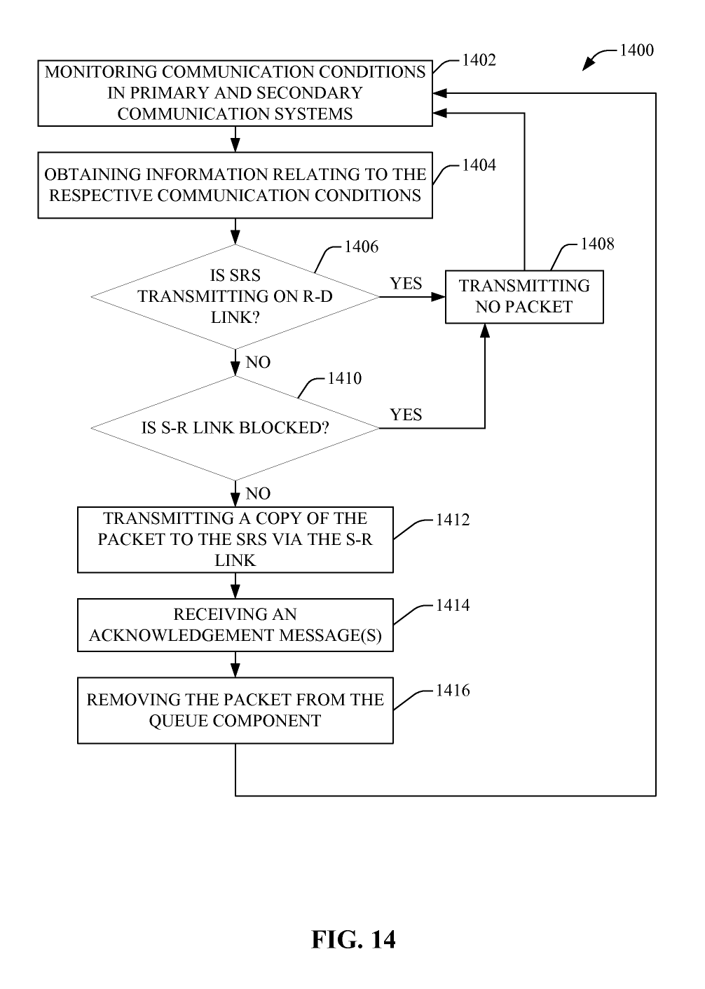

FIG. 14 depicts a flowchart of another example method 1400 that can employ a BDF protocol to facilitate controlling relaying of packets of information in a CRS, in accordance with various aspects and embodiments of the disclosed subject matter. The method 1400 can be employed, for example, by an SSD, employing the BDF protocol, to transmit at least a portion of one or more packets of information (e.g., voice or data), which are destined for an SDD, to an SRS for relay to the SDD, wherein the SSD and SDD are part of a secondary communication system, and wherein the SRS also manages and facilitates communications by one or more PUs in the primary communication system.

At 1402, communication conditions associated with one or more primary communication devices (e.g., PUs) associated with the primary communication system and communication conditions associated with secondary devices associated with a secondary communication system can be monitored. In an aspect, the SSD can monitor respective communication conditions (e.g., activity state of a PU, link status of respective links, link quality of respective links, etc.) associated with PUs utilizing the primary communication system and secondary devices (e.g., SSD, SDD) associated with the secondary communication system.

At 1404, information relating to the respective communication conditions can be obtained. In an aspect, the SSD can sense, detect, receive, or otherwise obtain information relating to the respective communication conditions associated with one or more PUs utilizing the primary communication system and respective communication conditions associated with the secondary devices (e.g., SSD, SDD) associated with the secondary communication system.

At 1406, a determination can be made regarding whether the SRS is transmitting on the R-D link between the SRS and SDD, based at least in part on the information relating to the communication conditions. The SSD can identify whether the SRS is transmitting on the R-D link, based at least in part on the information relating to the communication conditions. If it is determined that the SRS is transmitting on the R-D link, at 1408, no packet is transmitted from the SSD to the SRS at this time. At this point, if no packet is transmitted to the SRS by the SSD, method 1400 can return to reference numeral 1402, wherein the communication conditions can continue to be monitored. In an aspect, in instances where the SSD is not to transmit a packet to the SRS at a given time, in accordance with the BDF protocol, the SSD can directly transmit a packet to the SDD via the S-D link when the S-D link is not blocked, in accordance with the BL protocol, as more fully disclosed herein.

Referring again to reference numeral 1406, if, at 1406, it is determined that the SRS is not transmitting on the R-D link, at 1410, a determination can be made regarding whether the S-R link between the SSD and SRS is blocked at this time. The SSD can identify whether the S-R link is blocked, based at least in part on the information relating to the communication conditions. If it is determined that the S-R link is blocked at this time, method 1400 can proceed from reference numeral 1410 to reference numeral 1408, and, at 1408, no packet is transmitted to the SRS by the SSD at this time. At this point, if no packet is transmitted to the SRS by the SSD, method 1400 can return to reference numeral 1402, wherein the communication conditions can continue to be monitored.

Referring again to reference numeral 1410, if, at 1410, it is determined that the S-R link is not blocked at this time, at 1412, a copy of the packet can be transmitted to the SRS via the S-R link. In accordance with various aspects, the SSD can have one or more packets in a queue component (e.g., FIFO queue). The one or more packets can be encoded in accordance with a specified encoding algorithm or protocol to facilitate desired transmission of the one or more packets. When transmission of a packet is permitted, in accordance with an applicable relay protocol (e.g., BDF, BL), the SSD can generate a copy of the packet to be transmitted, while the SSD maintains an original version of the packet in the queue component until the SSD receives an acknowledgement message from the SDD and/or SRS indicating the packet has been successfully received by the SDD. At this point, in accordance with various embodiments, method 1400 can await acknowledgement from the SRS and/or SDD that a copy of the packet and/or a corresponding version of the original packet has been successfully received by the SRS and/or SDD, respectively, as more fully disclosed herein.

At 1414, an acknowledgement message, which can comprise information indicating the SRS and/or SDD has successfully received the packet and/or a copy of the version of the packet, respectively, can be received. For instance, in response to receiving the packet from the SSD, the SRS can generate and transmit an acknowledgement message, which indicates that the SRS has received the packet, to the SSD, which can receive such message; and/or in response to receiving the copy of the version of the packet, the SDD can generate and transmit an acknowledgement message to the SSD, which can receive such message.

At 1416, the packet (e.g., original packet maintained in the queue component) can be removed from the queue component. In accordance with various embodiments, the SSD can remove the packet from the queue component and discard such packet, in response to receiving an acknowledgement message(s) from the SRS and/or SDD. If there are any other packets in the queue component, the packets each can move up a slot in the queue component, in accordance with the predefined relay criteria. At this point, if there are additional packets of voice or data to communicate between the SSD and SDD, the method 1400 can proceed to reference numeral 1402, to continue to monitor the communication conditions, and to further proceed to determine whether and when to transmit packets to the SRS from an SSD.

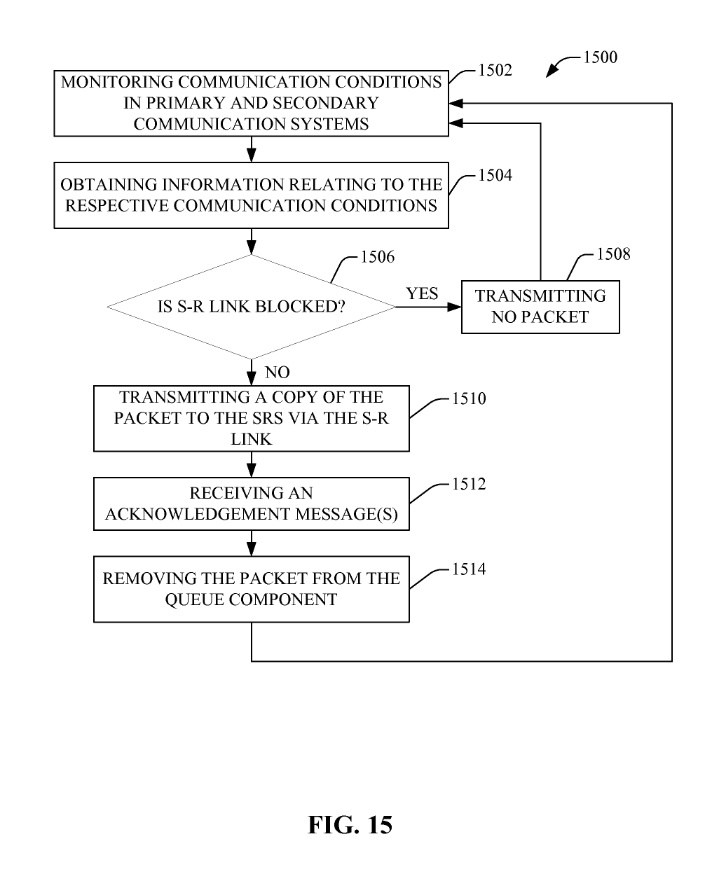

FIG. 15 illustrates a flowchart of another example method 1500 that can employ an SDF protocol to facilitate controlling relaying of packets of information in a CRS, in accordance with various aspects and embodiments of the disclosed subject matter. The method 1500 can be employed, for example, by an SSD, employing the SDF protocol, to transmit at least a portion of one or more packets of data, which are destined for an SDD, directly or indirectly via relay by an SRS in the CRS, wherein the SSD and SDD can be part of a secondary communication system, and wherein the SRS also manages and facilitates communications by one or more PUs in the primary communication system.

At 1502, communication conditions associated with one or more primary communication devices (e.g., PUs) associated with the primary communication system and communication conditions associated with secondary devices associated with a secondary communication system can be monitored. In an aspect, the SSD can monitor respective communication conditions (e.g., activity state of a PU, link status of respective links, link quality of respective links, etc.) associated with PUs utilizing the primary communication system and secondary devices (e.g., SSD, SDD) associated with the secondary communication system.

At 1504, information relating to the respective communication conditions can be obtained. For instance, the SSD can sense, detect, receive, or otherwise obtain information relating to the respective communication conditions associated with one or more PUs utilizing the primary communication system and respective communication conditions associated with the secondary devices (e.g., SSD, SDD) associated with the secondary communication system.

At 1506, a determination can be made regarding whether the S-R link between the SSD and SRS is blocked at this time. The SSD can identify whether the S-R link is blocked, based at least in part on the information relating to the communication conditions. If it is determined that the S-R link is blocked at this time, at 1508, no packet is transmitted to the SRS at this time. At this point, if no packet is transmitted to the SRS by the SSD, method 1500 can return to reference numeral 1502, wherein the communication conditions can continue to be monitored. In an aspect, in instances where the SSD is not to transmit a packet to the SRS at a given time, in accordance with the SDF protocol, the SSD can directly transmit a packet to the SDD via the S-D link when the S-D link is not blocked, in accordance with the BL protocol, as more fully disclosed herein.

Referring again to reference numeral 1506, if, at 1506, it is determined that the S-R link is not blocked at this time, at 1510, a copy of the packet can be transmitted to the SRS from the SSD via the S-R link. In accordance with various aspects, the SSD can have one or more packets in a queue component (e.g., FIFO queue). The one or more packets can be encoded in accordance with a specified encoding algorithm or protocol to facilitate desired transmission of the one or more packets. When transmission of a packet is permitted, in accordance with an applicable relay protocol (e.g., SDF, BL), the SSD can generate a copy of the packet to be transmitted, while the SSD maintains an original version of the packet in the queue component until the SSD receives an acknowledgement message from the SDD and/or SRS indicating the packet has been successfully received by the SDD. At this point, in accordance with various embodiments, the method 1500 can await acknowledgement from the SRS and/or SDD that the packet or a copy of a corresponding version of the packet has been successfully received by the SRS and/or SDD, respectively.

At 1512, an acknowledgement message(s), which can comprise information indicating the SRS and/or SDD has received the packet and/or a copy of the corresponding version of the packet, respectively, can be received. In an aspect, the SRS can receive the copy of the packet from the SSD, decode the copy of the packet to obtain the voice or data information, re-encode the voice or data information to generate a corresponding version of the packet, store the corresponding version of the packet in the SRS queue component, and transmit a copy of the corresponding version of the packet to the SDD, in accordance with the SDF protocol. In one aspect, the SRS can generate and transmit an acknowledgement message, which indicates that the SRS has received the packet, to the SSD. In another aspect, in response to receiving the copy of the corresponding version of the packet, the SDD can generate and transmit an acknowledgement message to the SRS and/or SSD, wherein the SRS and/or SSD can receive such message.

At 1514, the packet can be removed from the queue component. In accordance with various embodiments, the SSD can remove the packet (e.g., original copy of the packet) from the SSD queue component and discard such packet, in response to receiving the acknowledgement message(s) from the SRS and/or the SDD, as more fully disclosed herein. At this point, if there are additional packets of voice or data to communicate between the SSD and SDD, the method 1500 can proceed to reference numeral 1502, to continue to monitor the communication conditions, and to further proceed to determine whether and when to transmit packets to the SRS from the SSD.

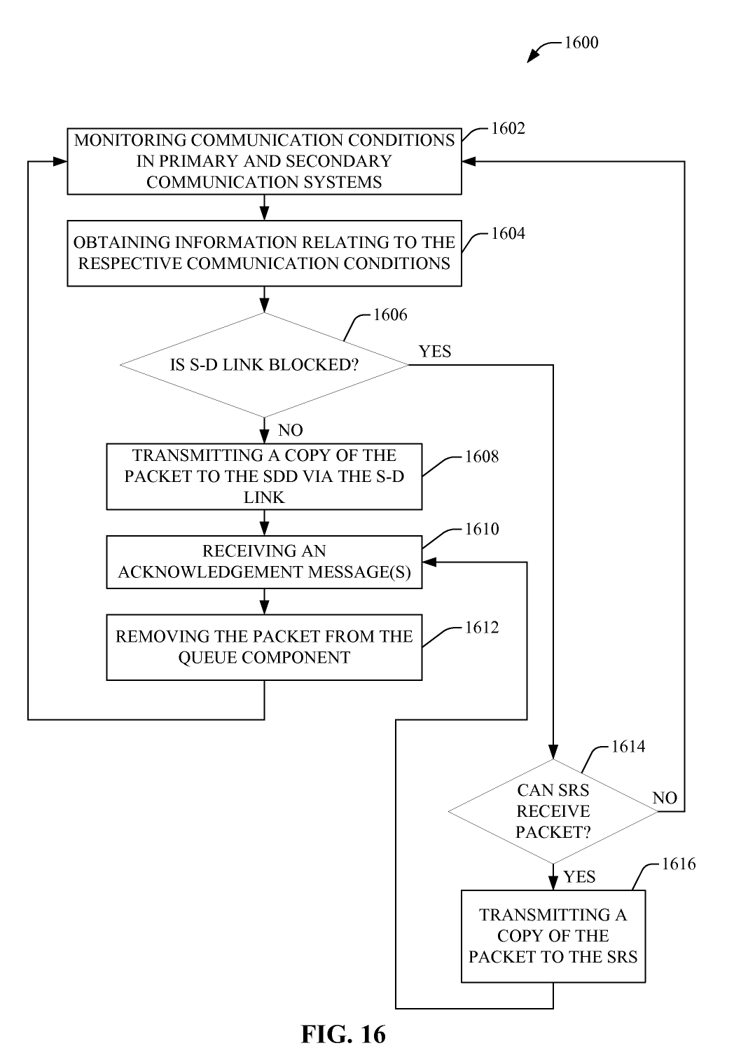

FIG. 16 depicts a flowchart of an example method 1600 that can employ a BL protocol to facilitate controlling transmitting packets of voice or data information in a CRS, in accordance with various aspects and embodiments of the disclosed subject matter. The method 1600 can be employed, for example, by an SSD, employing the BF protocol, to transmit at least a portion of one or more packets of data, which are destined for an SDD, directly to the SDD in at least some instances when the SRS is not available to receive and relay a packet, wherein the SSD and SDD can be part of a secondary communication system, and wherein the SRS can manage and facilitate communications by one or more PUs in the primary communication system.

At 1602, communication conditions associated with one or more primary communication devices (e.g., PUs) associated with the primary communication system and communication conditions associated with secondary devices associated with a secondary communication system can be monitored. In an aspect, the SSD can monitor respective communication conditions (e.g., activity state of a PU, link status of respective links, link quality of respective links, etc.) associated with PUs utilizing the primary communication system and secondary devices (e.g., SSD, SDD) associated with the secondary communication system.

At 1604, information relating to the respective communication conditions can be obtained. For instance, the SSD can sense, detect, receive, or otherwise obtain information relating to the respective communication conditions associated with one or more PUs utilizing the primary communication system and respective communication conditions associated with the secondary devices (e.g., SSD, SDD) associated with the secondary communication system.

At 1606, a determination can be made regarding whether the S-D link between the SSD and SDD is blocked at this time. The SSD can identify whether the S-D link is blocked, based at least in part on the information relating to the communication conditions. If it is determined that the S-D link is not blocked at this time, at 1608, a copy of the packet can be transmitted to the SDD via the S-D link. The SSD can generate a copy of the packet and transmit the copy of the packet to the SDD via the direct S-D link, while maintaining the original packet in the queue component of the SSD at least until an acknowledgement message, which indicates that the copy of the packet has been successfully received by the SDD, is received by the SSD.

At 1610, an acknowledgement message, which can comprise information indicating the SDD has received a copy of a version of the packet, can be received. In an aspect, in response to receiving the copy of the version of the packet, the SDD can generate and transmit an acknowledgement message to the SSD, wherein the SSD can receive such message. At 1612, the packet can be removed from the queue component. In an aspect, the SSD can remove the packet from the queue component and discard such packet, in response to receiving the acknowledgement message. At this point, if there are additional packets of voice or data to communicate between the SSD and SDD, the method 1600 can proceed to reference numeral 1602, to continue to monitor the communication conditions, and to further proceed to determine whether and when to directly transmit packets to the SDD from the SSD (and/or indirectly transmit packets to the SDD via the SRS).

Referring again to reference numeral 1606, if, at 1606, it is determined that the S-D link is blocked, at 1614, a determination can be made regarding whether the SRS can receive a packet at this time, in accordance with one or more specified relay protocols (e.g., BDF protocol, SDF protocol). If it is determined that the SRS can receive the packet at this time, at 1616, a copy of the packet can be transmitted to the SRS for relay to the SSD. For instance, the SSD can generate a copy of the next packet in its queue component and can transmit the copy of that packet to the SRS for relay to the SDD by the SRS. In accordance with various embodiments, as disclosed herein, the SSD can maintain the original copy of the packet in its queue component until the SSD receives an acknowledgement message(s) indicating the copy of the packet and/or a copy of the corresponding version of the packet (e.g., generated by the SRS) has been successfully received by the SRS and/or SDD, respectively. At this point, the method 1600 can return to reference numeral 1610, wherein the acknowledgement message can be received, and the method 1600 can proceed from that point.

Referring again to reference numeral 1614, if, at 1614, it is determined that the SRS cannot receive the packet at this time, in accordance with the applicable relay protocol, the method 1600 can return to reference numeral 1602, wherein communication conditions can continue to be monitored, and method 1600 can continue to proceed from that point to transmit the one or more packets from the SSD to the SDD directly via the S-D link, or indirectly via the S-R link for relay to the SDD by the SRS.

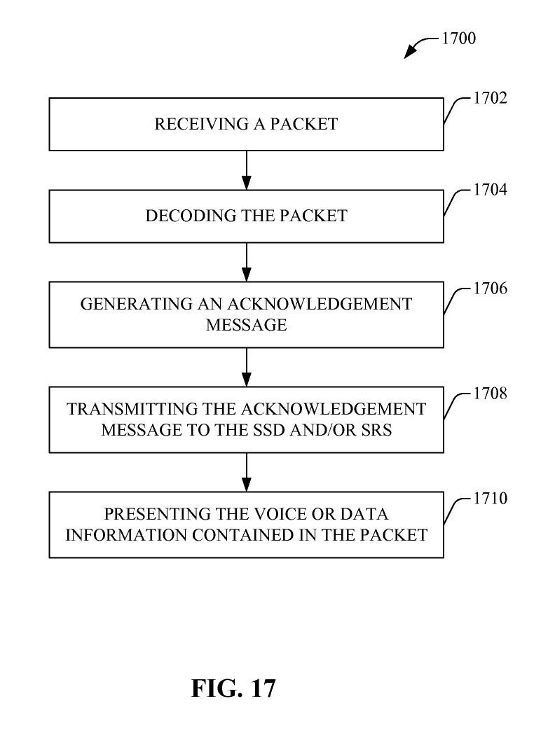

FIG. 17 illustrates a flowchart of an example method 1700 that can facilitate controlling communication of voice or data information between an SSD and an SDD associated with a CRS, in accordance with various aspects and embodiments of the disclosed subject matter. The method 1700 can be employed by the SDD to receive one or more packets of data directly from the SSD, or from the SSD indirectly via an SRS, wherein the SSD and SDD can be part of a secondary communication system, and wherein the SRS can manage and facilitate communications by one or more PUs in the primary communication system.

At 1702, a packet can be received. In an aspect, the SDD can receive a packet of voice or data information from the SSD or SRS. The packet can be received from the SSD directly via the S-D link, or from the SSD indirectly via an SRS using the R-D link. The received packet can a copy of the packet that corresponds to a packet in the queue component of the SSD, or can be copy of a corresponding version of the copy of the packet generated by the SRS when the SRS receives the copy of the packet and generates a corresponding version of the copy of the packet to relay the corresponding version of the copy of the packet to the SDD.

At 1704, the received packet can be decoded, in accordance with a specified decoding algorithm or protocol. In an aspect, the SDD can decode the received packet to obtain the voice or data information in the received packet. In another aspect, the specified decoding algorithm can correspond to the specified encoding algorithm or protocol that was employed to encode the packet.

At 1706, an acknowledgement message can be generated. In an aspect, the SDD can generate an acknowledgement message, which can comprise information indicating that the packet was successfully received by the SDD. At 1708, the acknowledgement message can be transmitted to the SSD and/or SRS. For instance, the acknowledgment message can be transmitted to the SSD or SRS via a control channel that can be employed to communicate control signals, including the acknowledgment message, to the SSD or SRS. At 1710, the voice or data information contained in the received packet can be presented. For example, the SDD can present the voice or data information obtained as a result of decoding the received packet.

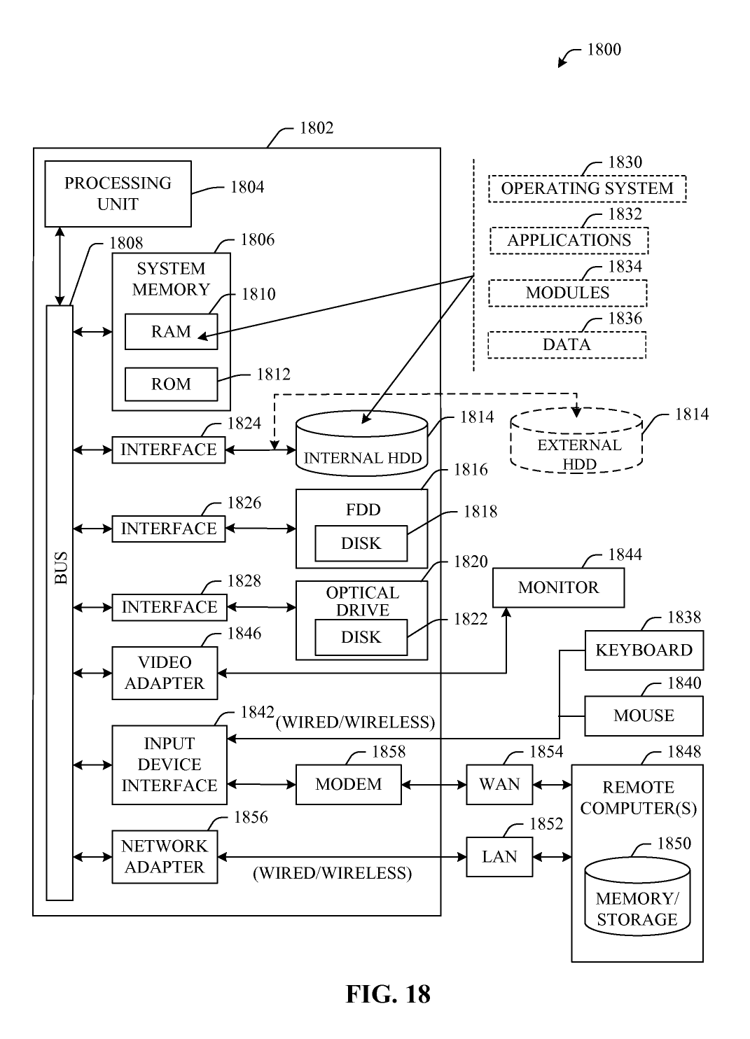

Referring now to FIG. 18, there is illustrated a block diagram of an exemplary computer system operable to execute aspects of the disclosed subject matter. In order to provide additional context for various aspects of the various embodiments, FIG. 18 and the following discussion are intended to provide a brief, general description of a suitable computing environment 1800 in which the various aspects of the various embodiments can be implemented. Additionally, while the various embodiments described above may be suitable for application in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Continuing to reference FIG. 18, the exemplary environment 1800 for implementing various aspects of one or more of the various embodiments includes a computer 1802, the computer 1802 including a processing unit 1804, a system memory 1806 and a system bus 1808. The system bus 1808 couples to system components including, but not limited to, the system memory 1806 to the processing unit 1804. The processing unit 1804 can be any of various commercially available processors. Dual microprocessors and other multi-processor architectures may also be employed as the processing unit 1804.

The system bus 1808 can be any of several types of bus structure that may further interconnect to a memory bus (with or without a memory controller), a peripheral bus, and a local bus using any of a variety of commercially available bus architectures. The system memory 1806 includes read-only memory (ROM) 1810 and random access memory (RAM) 1812. A basic input/output system (BIOS) is stored in a non-volatile memory 1810 such as ROM, EPROM, EEPROM, which BIOS contains the basic routines that help to transfer information between elements within the computer 1802, such as during start-up. The RAM 1812 can also include a high-speed RAM such as static RAM for caching data.

The computer 1802 further includes an internal hard disk drive (I-IDD) 1814 (e.g., EIDE, SATA), which internal hard disk drive 1814 may also be configured for external use in a suitable chassis (not shown), a magnetic floppy disk drive (FDD) 1816, (e.g., to read from or write to a removable diskette 1818) and an optical disk drive 1820, (e.g., reading a CD-ROM disk 1822 or, to read from or write to other high capacity optical media such as the DVD). The hard disk drive 1814, magnetic disk drive 1816 and optical disk drive 1820 can be connected to the system bus 1808 by a hard disk drive interface 1824, a magnetic disk drive interface 1826 and an optical drive interface 1828, respectively. The interface 1824 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the various embodiments.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. It is appreciated that the various embodiments can be implemented with various commercially available operating systems or combinations of operating systems.

A user can enter commands and information into the computer 1802 through one or more wired/wireless input devices, e.g., a keyboard 1838 and a pointing device, such as a mouse 1840. Other input devices (not shown) may include a microphone, an IR remote control, a joystick, a game pad, a stylus pen, touch screen, or the like. These and other input devices are often connected to the processing unit 1804 through an input device interface 1842 that is coupled to the system bus 1808, but can be connected by other interfaces, such as a parallel port, an IEEE1394 serial port, a game port, a USB port, an IR interface, etc.

A monitor 1844 or other type of display device is also connected to the system bus 1808 via an interface, such as a video adapter 1846. In addition to the monitor 1844, a computer typically includes other peripheral output devices (not shown), such as speakers, printers, etc.

The computer 1802 may operate in a networked environment using logical connections via wired and/or wireless communications to one or more remote computers, such as a remote computer(s) 1848. The remote computer(s) 1848 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1850 is illustrated. The logical connections depicted include wired/wireless connectivity to a local area network (LAN) 1852 and/or larger networks, e.g., a wide area network (WAN) 1854. Such LAN and WAN networking environments are commonplace in offices and companies, and facilitate enterprise-wide computer networks, such as intranets, all of which may connect to a global communications network, e.g., the Internet.

When used in a LAN networking environment, the computer 1802 is connected to the local network 1852 through a wired and/or wireless communication network interface or adapter 1856. The adapter 1856 may facilitate wired or wireless communication to the LAN 1852, which may also include a wireless access point disposed thereon for communicating with the wireless adapter 1856.

When used in a WAN networking environment, the computer 1802 can include a modem 1858, or is connected to a communications server on the WAN 1854, or has other means for establishing communications over the WAN 1854, such as by way of the Internet. The modem 1858, which can be internal or external and a wired or wireless device, is connected to the system bus 1808 via the serial port interface 1842. In a networked environment, program modules depicted relative to the computer 1802, or portions thereof, can be stored in the remote memory/storage device 1850. It will be appreciated that the network connections shown are exemplary and other means of establishing a communications link between the computers can be used.

The computer 1802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11(a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

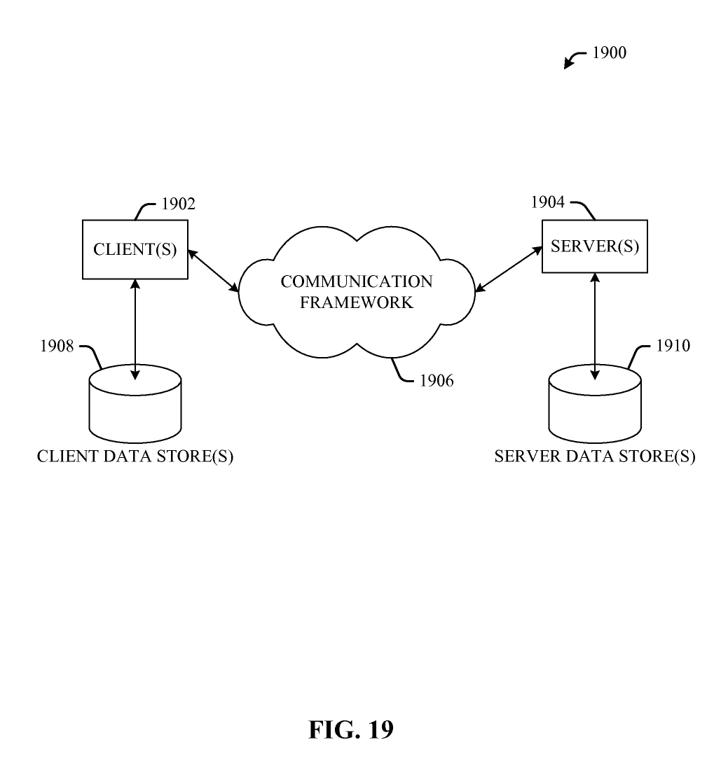

Referring now to FIG. 19, there is illustrated a schematic block diagram of an exemplary computer compilation system operable to execute the disclosed architecture. The system 1900 includes one or more client(s) 1902. The client(s) 1902 can be hardware and/or software (e.g., threads, processes, computing devices). The client(s) 1902 can house cookie(s) and/or associated contextual information by employing the various embodiments, for example.

The system 1900 also includes one or more server(s) 1904. The server(s) 1904 can also be hardware and/or software (e.g., threads, processes, computing devices). The servers 1904 can house threads to perform transformations by employing the various embodiments, for example. One possible communication between a client 1902 and a server 1904 can be in the form of a data packet adapted to be transmitted between two or more computer processes. The data packet may include a cookie and/or associated contextual information, for example. The system 1900 includes a communication framework 1906 (e.g., a global communication network such as the Internet) that can be employed to facilitate communications between the client(s) 1902 and the server(s) 1904.

Communications can be facilitated via a wired (including optical fiber) and/or wireless technology. The client(s) 1902 are operatively connected to one or more client data store(s) 1908 that can be employed to store information local to the client(s) 1902 (e.g., cookie(s) and/or associated contextual information). Similarly, the server(s) 1904 are operatively connected to one or more server data store(s) 1910 that can be employed to store information local to the servers 1904.

It is to be appreciated and understood that components (e.g., UE, base station, SSD, SRS, SDD, CRCM component, communication management component, communication network, core network, IP-based network, etc.), as described with regard to a particular system or method, can include the same or similar functionality as respective components (e.g., respectively named components) as described with regard to other systems or methods disclosed herein.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” data storage,” “database,” and substantially any other information storage component relevant to operation and functionality of a component, refer to “memory components,” or entities embodied in a “memory” or components comprising the memory. For example, information relevant to operation of various components described in the disclosed subject matter, and that can be stored in a memory, can comprise, but is not limited to comprising, subscriber information; cell configuration (e.g., devices served by an AP) or service policies and specifications; privacy policies; and so forth. It will be appreciated that the memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), phase change memory (PCM), flash memory, or nonvolatile RAM (e.g., ferroelectric RAM (FeRAM)). Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD), Blu-ray disc (BD), . . . ), smart cards, and flash memory devices (e.g., card, stick, key drive . . . ).

What has been described above includes examples of the various embodiments. It is, of course, not possible to describe every conceivable combination of components or methods for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising”, such as, for example, as the term “comprising” is interpreted when employed as a transitional word in a claim.

What is claimed is:

1. A system, comprising:
a secondary relay station (SRS) configured to control communications associated with one or more primary communication devices associated with a primary communication system; and
a cognitive relay communications management (CRCM) component configured to control reception of a packet of information by the SRS from a secondary source device (SSD) and communication of a corresponding version of the packet of information by the SRS to a secondary destination device (SDD) based at least in part on respective activity states of at least a portion of the one or more primary communication devices, in accordance with a specified relay protocol, wherein the SSD and the SDD are associated with a secondary communication system.

2. The system of claim 1, further comprising:
an SRS queue component associated with the SRS and configured to contain a specified number of slots for storage of one or more packets of information, wherein the CRCM component is further configured to, when the packet is received by the SRS, decode the packet to obtain voice or data information in the packet, and encode the voice or data information, in accordance with an encoding protocol, to generate the corresponding version of the packet of information and store the corresponding version of the packet in the SRS queue component.

3. The system of claim 2, wherein the CRCM component is further configured to enable the SRS to receive the packet from the SSD when the CRCM component identifies a source-relay communication link between the SSD and SRS as not being blocked and identifies that there is no transmission by the SRS on a relay-destination communication link between the SRS and SDD, in accordance with the specified relay protocol, comprising a buffered decode-and-forward (BDF) protocol.

4. The system of claim 3, wherein the CRCM component is further configured to identify the source-relay communication link as not being blocked when a block indicator variable has a value indicative of the source-relay communication link not being blocked and no primary communication devices of a specified subset of primary communication devices in an interference region are identified as being active in relation to the source-relay communication link, wherein the value of the block indicator variable is determined as a function of power used to transmit a signal on the source-relay communication link.

5. The system of claim 3, wherein the CRCM component is further configured to generate a copy of the corresponding version of the packet and transmit the copy of the corresponding version of the packet to the SDD when the relay-destination communication link is not blocked, in accordance with the specified relay protocol, comprising the BDF protocol.

6. The system of claim 2, wherein the CRCM component is further configured to enable the SRS to receive the packet from the SSD when a source-relay communication link between the SSD and SRS is not blocked, in accordance with the specified relay protocol, comprising a simple decode-and-forward (SDF) protocol.

7. The system of claim 6, wherein the CRCM component is further configured to generate a copy of the corresponding version of the packet and transmit the copy of the corresponding version of the packet to the SDD via a relay-destination communication link, in accordance with the specified relay protocol, comprising the SDF protocol.

8. The system of claim 2, wherein the SRS queue component is further configured to comprise a first-in-first-out queue.

9. The system of claim 2, wherein the SSD is further configured to comprise an SSD queue component configured to contain a specified number of slots for storage of one or more packets of information, comprising an original packet that corresponds to the packet, wherein the SSD is further configured to generate the packet as a copy of the original packet and transmit the packet to the SRS when transmission of the packet is in accordance with the specified relay protocol.

10. The system of claim 9, wherein the CRCM component is further configured to remove the corresponding version of the packet from the SRS queue component in response to reception of an SDD acknowledgement message from the SDD, wherein the SDD acknowledgement message comprises information that indicates the copy of the corresponding version of the packet was successfully received by the SDD; and the SSD is further configured to remove the original packet from the SSD queue component, in response to reception of an SRS acknowledgement message from the SRS or an SDD acknowledgment message from the SDD, wherein the SRS acknowledgement message comprises information that indicates the packet was successfully received by the SRS.

11. The system of claim 10, wherein the SRS queue component and the SSD queue component are respectively configured to maintain stability simultaneously.

12. The system of claim 1, wherein the SRS component is further configured to generate and transit an SRS acknowledgement message to the SSD when the SRS successfully receives the packet from the SSD, wherein the SRS acknowledgement message comprises information that indicates the packet was successfully received by the SRS.

13. The system of claim 1, wherein the SSD is further configured to transmit at least one other packet to the SDD when a source-destination communication link between the SSD and SDD is not blocked, in accordance with a baseline protocol.

14. The system of claim 1, wherein the SRS is further configured to be a half-duplex cognitive relay station comprising a plurality of antennas, wherein the half-duplex cognitive relay station is configured to operate in a half-duplex mode to facilitate identification of whether the packet is to be received from the SSD and whether the corresponding packet of information, comprising voice or data information contained in the packet, is to be transmitted to the SDD.

15. The system of claim 1, wherein the CRCM component of the SRS and the SSD respectively obtain information from one or more sensors comprising a first subset of sensors that obtain information relating to communication conditions associated with the SSD or SDD, and a second subset of sensors distributed throughout a communication network environment to obtain information regarding respective communication conditions, including respective activity states, of the one or more primary communication devices, wherein the information obtained from the one or more sensors is utilized by the CRCM component and SSD to respectively identify whether and when the packet is to be transmitted by the SSD to the SRS, or identify whether and when the SRS is to transmit the corresponding version of the packet to the SDD, based at least in part on respective activity states of the one or more primary communication devices, in accordance with a specified relay protocol.

16. The system of claim 1, wherein the SRS is further configured to enable reception of the packet from the SSD and transmission of the packet from the SRS to the SDD via use of an unused portion of spectrum associated with the primary communication system, in accordance with the specified relay protocol.

17. The system of claim 1, wherein the SSD is one of a base station or a mobile communication device, and the SDD is one of the mobile communication device or the base station, and wherein the mobile communication device is one of a wireless phone, a cellular phone, a smart phone, a personal digital assistant (PDA), a computer, an information server, a video server, an audio server, a multimedia server, a television, an electronic gaming console, a set-top box, a multimedia recorder or player, a video recorder or player, an audio recorder or player, a printer, or a multi-mode printer.

18. A method, comprising:
receiving a packet, which is destined for a secondary destination device (SDD), from a secondary source device (SSD) at a secondary relay device (SRD) in response to a source-relay (S-R) link between the SSD and SRD not being blocked and there being no other condition restricting the receiving of the packet, based at least in part on respective activity states of at least a portion of one or more primary communication devices associated with a primary communication network in relation to the S-R link, in accordance with at least one predefined relay criterion; and
transmitting a corresponding version of the packet, comprising voice or data information of the packet, to relay the corresponding version of the packet to the SDD, based at least in part on respective activity states of at least a portion of one or more primary communication devices associated with a primary communication network, in accordance with the at least one predefined relay criterion, wherein the SSD and SDD are associated with a secondary communication network.

19. The method of claim 18, further comprising:
controlling communications of the one or more primary communication devices communicating in the primary communication network at the SRD; and
concurrently controlling at least a portion of communications between the SSD and SDD associated with the secondary communication network at the SRD to facilitate utilizing a portion of available spectrum associated with the primary communication network for communication of one or more packets of voice or data information between the SSD and SDD via the primary communication network.

20. The method of claim 19, further comprising:
identifying a value of a link block indicator variable in relation to at least one of the S-R link or a relay-destination (R-D) link at a given time;
identifying whether any primary communication device of the at least a portion of the primary communication devices is active at a given time; and
identifying whether the at least one of the S-R link or the R-D link is blocked based at least in part on the value of the link block indicator variable and the any primary communication device of the at least a portion of the primary communication devices is active at the given time.

21. The method of claim 20, further comprising:
sensing communication conditions associated with the at least a portion of the one or more primary communication devices in the primary communication network;
obtaining communication condition information relating to the sensed communication conditions associated with the at least a portion of the one or more primary communication devices; and
identifying the respective activity states of the at least a portion of the one or more primary communication devices based at least in part on the communication condition information.

22. The method of claim 18, further comprising:
identifying whether the S-R link is blocked;
identifying whether the SRD is transmitting on a relay-destination (R-D) link;
receiving the packet when the S-R link is not blocked and the SRD is not transmitting on the R-D link, in accordance with a buffered decode-and-forward (BDF) protocol; and
transmitting an SRD acknowledgment message to the SSD.

23. The method of claim 18, further comprising:
identifying whether a relay-destination (R-D) link is blocked;
generating a copy of the corresponding version of the packet; and
transmitting the copy of the corresponding version of the packet via the R-D link when the R-D link is not blocked, in accordance with a buffered decode-and-forward (BDF) protocol.

24. The method of claim 18, further comprising:
identifying whether the S-R link is blocked;
receiving the packet when the S-R link is not blocked, in accordance with a simple decode-and-forward (SDF) protocol;
transmitting an SRD acknowledgement message to the SSD;
generating a copy of the corresponding version of the packet; and
transmitting the copy of the corresponding version of the packet to the SDD via a relay-destination link.

25. The method of claim 18, further comprising:
at least one of:
receiving an SRD acknowledgement message, comprising information indicating that the SRD has successfully received the packet, or
receiving an SDD acknowledgement message, comprising information indicating that the SDD has successfully received a copy of the corresponding version of the packet; and
at least one of:
removing an original packet corresponding to the packet from a SSD queue of the SSD, in response to receiving at least one of the SRD acknowledgement message or the SDD acknowledgement message,
removing the corresponding version of the packet from a SRD queue of the SRD, in response to receiving the SDD acknowledgement message.

26. The method of claim 18, further comprising:
concurrently stabilizing an SRD queue of the SRD and SSD queue of the SSD to facilitate utilizing a buffered decode-and-forward (BDF) protocol.

27. The method of claim 18, further comprising:
identifying whether a source-destination (S-D) link is blocked;
generating a copy of an other packet; and
transmitting the copy of the other packet from the SSD to the SDD via the S-D link when the S-D link is not blocked, in accordance with a baseline protocol.

28. A system, comprising:
means for receiving a packet, which is destined for a secondary destination device (SDD), from a secondary source device (SSD) at a secondary relay device (SRD) in response to a source-relay (S-R) link between the SSD and SRD not being blocked and there being no other condition restricting the receiving of the packet, based at least in part on respective activity states of at least a portion of one or more primary communication devices associated with a primary communication system in relation to the S-R link, in accordance with at least one predefined relay criterion; and
means for transmitting a corresponding version of the packet, comprising voice or data information of the packet, to relay the corresponding version of the packet to the SDD, based at least in part on respective activity states of at least a portion of one or more primary communication devices associated with a primary communication system, in accordance with the at least one predefined relay criterion, wherein the SSD and SDD are associated with a secondary communication system.

29. A computer-readable medium having stored thereon, computer-executable instructions that, when executed by a computing device, cause the computing device to perform operations comprising:
receiving a packet, which is destined for a secondary destination device (SDD), from a secondary source device (SSD) at a secondary relay device (SRD) in response to a source-relay (S-R) link between the SSD and SRD being free and there being no other condition restricting the receiving of the packet, based at least in part on respective activity states of at least a portion of one or more primary communication devices associated with a primary communication network in relation to the S-R link, in accordance with at least one predefined relay criterion; and
transmitting a corresponding version of the packet, comprising voice or data information of the packet, to relay the corresponding version of the packet to the SDD, based at least in part on respective activity states of at least a portion of one or more primary communication devices associated with a primary communication network, in accordance with the at least one predefined relay criterion, wherein the SSD and SDD are associated with a secondary communication network.

30. A system, comprising:
a secondary source device (SSD) configured to transmit at least a first portion of a set of packets via a source-destination communication link to a secondary destination device (SDD), and a second portion of the set of packets via a source-relay communication link to a secondary relay station (SRS) to have the SRS forward the second portion of the set of packets to the SDD via a relay-destination communication link; and
a communication management component configured to control transmission of a packet of the second portion of the set of packets to the SRS based at least in part on respective activity states of at least a portion of one or more primary communication devices associated with a primary communication system, in accordance with a specified relay protocol, wherein the SSD and the SDD are associated with a secondary communication system.

31. The system of claim 30, wherein the communication management component is further configured to transmit a copy of a packet of the second portion of the set of packets from the SSD to the SRS when the communication management component identifies a source-relay communication link between the SSD and SRS as not being blocked and identifies that there is no transmission by the SRS on a relay-destination communication link between the SRS and SDD, in accordance with the specified relay protocol, comprising a buffered decode-and-forward (BDF) protocol.

32. The system of claim 30, wherein the communication management component is further configured to transmit a copy of a packet of the second portion of the set of packets from the SSD to the SRS when a source-relay communication link between the SSD and SRS is not blocked, in accordance with the specified relay protocol, comprising a simple decode-and-forward (SDF) protocol.

33. The system of claim 30, wherein the communication management component is further configured to transmit a copy of a packet of the first portion of the set of packets to the SDD via a source-destination communication link when the source-destination communication link between the SSD and SDD is not blocked, in accordance with a baseline protocol.

34. The system of claim 30, further comprising:
an SSD queue component associated with the SSD and configured to contain a specified number of slots for storage of the set of packets, wherein the communication management component is further configured to encode voice or data information to generate the set of packets, in accordance with an encoding protocol, and store the set of packets in the SSD queue component.

35. The system of claim 34, wherein the communication management component is further configured to remove a packet of at least one of the first portion of the set of packets or the second portion of the set of packets from the SSD queue component in response to at least one of:
a received SRS acknowledgement message comprising information that indicates a copy of the packet was received by the SRS, or
a received SDD acknowledgement message comprising information that indicates a copy of the packet or a copy of a corresponding version of the packet was received by the SDD.
